(19) United States
(12) Patent Application Publication
(10) Pub. No.: US 2018/0233727 A1
(43) Pub. Date: Aug. 16, 2018

(54) SEPARATOR FOR A NON-AQUEOUS SECONDARY BATTERY AND NON-AQUEOUS SECONDARY BATTERY

(71) Applicant: TEIJIN LIMITED, Osaka (JP)

(72) Inventors: Hiroshi Sakurai, Osaka-shi (JP); Satoshi Nishikawa, Osaka-shi (JP)

(73) Assignee: TEIJIN LIMITED, Osaka (JP)

(21) Appl. No.: 15/896,299

(22) Filed: Feb. 14, 2018

(30) Foreign Application Priority Data
Feb. 16, 2017 (JP) 2017-026981
Feb. 22, 2017 (JP) 2017-031095
Mar. 3, 2017 (JP) 2017-040395

(51) Int. Cl. H01M 2/16; H01M 2/18; H01M 10/058; H01M 4/40

(52) U.S. Cl. CPC H01M 2/1633; H01M 4/405; H01M 10/058; H01M 2/18

(57) ABSTRACT

A separator for a non-aqueous secondary battery, containing a porous substrate, and an adhesive porous layer that is provided on one side or both sides of the porous substrate and contains an acrylic type resin and a polyvinylidene fluoride type resin, the adhesive porous layer has a porous structure in which the acrylic type resin and the polyvinylidene fluoride type resin are contained in a mixed state, a content of the acrylic type resin in the adhesive porous layer is from 2 to 40% by mass with respect to a total mass of the acrylic type resin and the polyvinylidene fluoride type resin, and the acrylic type resin is a copolymer containing an acrylic type monomer and a styrene type monomer as monomer components, or the acrylic type resin is a copolymer containing, as monomer components, a first monoacrylate type monomer, and a second monoacrylate type monomer that has an oxyalkylene structural unit with a repetition number of from 2 to 10,000.

### CROSS-REFERENCE TO RELATED APPLICATIONS

This application claims priority under 35 USC 119 from Japanese Patent Application No. 2017-026981 filed on Feb. 16, 2017, Japanese Patent Application No.2017-031095 filed on Feb. 22, 2017, and Japanese Patent Application No. 2017-040395 filed on Mar. 3, 2017, the disclosures of which are incorporated by reference herein.

### BACKGROUND

### Technical Field

The present invention relates to a separator for a non-aqueous secondary battery and a non-aqueous secondary battery.

### Related Art

Non-aqueous secondary batteries represented by lithium ion secondary batteries are widely used as power sources for portable electronic devices such as notebook-size personal computers, mobile phones, digital cameras and camcorders. Outer packagings of non-aqueous secondary batteries have been simplified and lightened with size reduction and weight reduction of portable electronic devices, and as outer packaging materials, aluminum cans have been developed in place of stainless cans, and further, aluminum laminated film packages have been developed in place of metallic cans. However, an aluminum laminated film package is soft, and therefore in a battery having the package as an outer packaging material (a so called soft package battery), a gap is easily formed between an electrode and a separator due to external impact, or electrode expansion and shrinkage associated with charge-discharge, so that the cycle life of the battery may be reduced.

For solving the above-mentioned problem, techniques for improving adhesion between an electrode and a separator have been proposed. As one of the techniques, a separator including a porous layer containing a polyvinylidene fluoride type resin on a porous substrate is known (see, for example, Japanese Patent No. 4127989).

A laminated body with a separator disposed between a positive electrode and a negative electrode may be subjected to dry heat press (heat press treatment performed without impregnating a separator with an electrolytic solution) in production of a battery. If a separator favorably adheres to an electrode with each other by dry heat press, it is possible to improve a battery production yield. However, a prior art as in Japanese Patent No. 4127989 is lacking in function of adhering a separator to an electrode by dry heat press.

WO 2016/98684 discloses a separator having an adhesive porous layer on a surface of a porous substrate, the adhesive porous layer containing a polyvinylidene fluoride type resin and an acrylic type resin in mixture. According to such a separator, improvement of a battery production yield is expected because the separator favorably adheres to an electrode with each other by dry heat press. However, when such a separator is provided, dry heat press is performed with the separator disposed between a positive electrode and a negative electrode, and the separator is then impregnated with an electrolytic solution, there is a case where the acrylic type resin is swollen or dissolved with the electrolytic solution, so that the separator is easily peeled off from the electrodes. In this case, even when the separator adheres to the electrode with each other by dry heat press, a gap is formed between the separator and the electrode in a state in Which the separator is actually immersed in the electrolytic solution in a battery, and as a result of which the cycle life may be reduced when the battery is used for a long period of time (first problem).

In addition, Japanese Patent No. 3997573 discloses a method in which a mixture of a polyvinylidene fluoride type resin and an ion conductive polymer such as polyethylene glycol is applied to a separator for the purpose of improving battery characteristics such as charge-discharge characteristics. However, even this method has the problem that a structural part contributing to ion conductivity reduces adhesive strength, and pores of the separator are crushed by application of an adhesive to the separator, leading to an increase in internal resistance of a battery (second problem).

### SUMMARY

### Technical Problem

In view of a background associated with the first problem, a separator is desired Which has favorable adhesiveness to an electrode by dry heat press, and maintains a favorable adhering state to the electrode even when impregnated with an electrolytic solution after being adhered by dry heat press.

In view of a background associated with the second problem, a separator is desired which has favorable adhesiveness to an electrode by dry heat press, and has low ion conduction resistance.

A first embodiment has been made for solving the first problem.

An object of the first embodiment is to provide a separator for a non-aqueous secondary battery which includes an adhesive porous layer containing a polyvinylidene fluoride type resin, has favorable adhesiveness to an electrode by dry heat press, and has excellent adhesiveness to the electrode after being subsequently immersed in an electrolytic solution. This embodiment achieves the object.

A second embodiment has been made for solving the second problem.

An object of the second embodiment is to provide a separator for a non-aqueous secondary battery which includes an adhesive porous layer containing a polyvinylidene fluoride type resin, has favorable adhesiveness to an electrode by dry heat press, and has low ion conduction resistance. This embodiment achieves the object.

### Solution to Problem

The first embodiment of the invention employs the following constitutions.
[1] A separator for a non-aqueous secondary battery including a porous substrate, and an adhesive porous layer that is provided on one side or both sides of the porous substrate and contains an acrylic type resin and a polyvinylidene fluoride type resin, wherein the adhesive porous layer has a porous structure in which the acrylic type resin and the polyvinylidene fluoride type resin are contained in a mixed state, a content of the acrylic type resin in the adhesive porous layer is from 2% by mass to 40% by mass with respect to a total mass of the acrylic type resin and the polyvinylidene fluoride type resin, and the acrylic type resin is a copolymer containing an acrylic type monomer and a styrene type monomer as monomer components.
[2] The separator for a non-aqueous secondary battery according to [1], wherein the acrylic type resin is a copolymer containing an acrylic type monomer, a styrene type monomer, and an unsaturated carboxylic anhydride as monomer components.
[3] The separator for a non-aqueous secondary battery according to [1] or [2], wherein the acrylic type monomer is at least one selected from the group consisting of an acrylic acid, an acrylic acid salt, an acrylic acid ester, a methacrylic acid, a methacrylic acid salt and a methacrylic acid ester.
[4] The separator for a non-aqueous secondary battery according to [1], wherein the acrylic type resin is a terpolymer containing, as monomer components, two acrylic type monomers selected from the group consisting of 2-hydroxyethyl methacrylate, ethyl acrylate, butyl acrylate, methyl methacrylate and polymethoxydiethylene glycol (meth)acrylate, and a styrene type monomer.
[5] The separator for a non-aqueous secondary battery according to any one of [1] to [4], wherein the polyvinylidene fluoride type resin is a copolymer containing vinylidene fluoride and hexafluoropropylene as monomer components, a content of the hexafluoropropylene monomer component in the copolymer is from 3% by mass to 20% by mass, and a weight average molecular weight of the copolymer is from 100,000 to 1,500,000.
[6] A non-aqueous secondary battery including a positive electrode, a negative electrode, and the separator for a non-aqueous secondary battery according to any one of [1] to [5], which is disposed between the positive electrode and the negative electrode, wherein an electromotive force is produced by lithium doping and dedoping.

The second embodiment of the invention employs the following constitutions, [1] A separator for a non-aqueous secondary battery including a porous substrate, and an adhesive porous layer that is provided on one side or both sides of the porous substrate and contains an acrylic type resin and a polyvinylidene fluoride type resin, wherein the adhesive porous layer has a porous structure in which the acrylic type resin and the polyvinylidene fluoride type resin are contained in a mixed state, a content of the acrylic type resin in the adhesive porous layer is from 2% by mass to 40% by mass with respect to a total mass of the acrylic type resin and the polyvinylidene fluoride type resin, and the acrylic type resin is a copolymer containing, as monomer components, a first monoacrylate type monomer, and a second monoacrylate type monomer that has an oxyalkylene structural unit with a repetition number of from 2 to 10,000.
[2] The separator for a non-aqueous secondary battery according to [1], wherein the first monoacrylate type monomer has at least one structural unit selected from the group consisting of an acrylic acid, an acrylic acid salt, an acrylic acid ester, a methacrylic acid, a methacrylic acid salt and a methacrylic acid ester.
[3] The separator for a non-aqueous secondary battery according to [1] or [2], wherein a ratio of the second monoacrylate type monomer in the acrylic type resin is from 30% by mass to 95% by mass.
[4] The separator for a non-aqueous secondary battery according to any one of [1] to [3], wherein the polyvinylidene fluoride type resin is a copolymer containing vinylidene fluoride and hexafluoropropylene as monomer components, a content of the hexafluoropropylene monomer component in the copolymer is from 3% by mass to 20% by mass, and a weight average molecular weight of the copolymer is from 100,000 to 1,500,000.
[5] A non-aqueous secondary battery including a positive electrode, a negative electrode, and the separator for a non-aqueous secondary battery according to any one of [1] to [4] , which is disposed between the positive electrode and the negative electrode, wherein an electromotive force is produced by lithium doping and dedoping.

### Advantageous Effects of Invention

The first embodiment provides a separator for a non-aqueous secondary battery which includes an adhesive porous layer containing a polyvinylidene fluoride type resin, has favorable adhesiveness to an electrode by dry heat press, and has excellent adhesiveness to the electrode after being subsequently immersed in an electrolytic solution.

The second embodiment provides a separator for a non-aqueous secondary battery which includes an adhesive porous layer containing a polyvinylidene fluoride type resin, has favorable adhesiveness to an electrode by dry heat press, and has low ion conduction resistance.

### DESCRIPTION OF EMBODIMENTS

Hereinafter, the first and second embodiments of the present invention will be described. Note that the following explanation and examples merely illustrate the invention and are not intended to limit the scope of the invention. Unless otherwise noted, the terms “of the present disclosure” and “in the present specification” represent both the first and second embodiments.

Further, in the present disclosure, the numerical range indicated by “to” refers to a range including respective values presented before and after “to” as a minimum and a maximum, respectively.

In the present disclosure, the term “step” refers not only to an independent step, but also to a step that cannot be clearly distinguished from other steps as long as an expected object of the step is achieved.

When the amount of each component in a composition is mentioned in the present disclosure, the amount, when there exist a plurality of substances corresponding to each component in the composition, means the total amount of the plurality of substances existing in the composition unless otherwise specified.

In the present disclosure, the term “machine direction” means a longitudinal direction of a porous substrate and a separator that are produced into a long shape, and the term “width direction” means a direction perpendicular to the “machine direction”. In the present disclosure, the term “machine direction” is also referred to as a “MD direction”, and the term “width direction” is also referred to as a “TD direction”.

In the present specification, the term “monomer component” of a copolymer means a constituent component of the copolymer, which is a constituent unit obtained by polymerizing monomers.

[Separator for a Non-Aqueous Secondary Battery of First Embodiment]

A separator for a non-aqueous secondary battery (also referred to as a “separator”) of the first embodiment includes a porous substrate, and an adhesive porous layer provided on one side or both sides of the porous substrate.

In the separator of the first embodiment, the adhesive porous layer has a porous structure including an acrylic type resin and a polyvinylidene fluoride type resin in a mixed state. The adhesive porous layer contains the acrylic type resin in an amount of from 2 to 40% by mass with respect to the total mass of the acrylic type resin and the polyvinylidene fluoride type resin. It is important that the acrylic type resin is a copolymer containing an acrylic type monomer and a styrene type monomer as monomer components.

The acrylic type resin may be a terpolymer containing, as monomer components, two acrylic type monomers selected from the group consisting of 2-hydroxyethyl methacrylate, ethyl acrylate, butyl acrylate, methyl methacrylate and polymethoxydiethylene glycol (meth)acrylate, and a styrene type monomer.

The separator of the first embodiment is excellent in adhering to an electrode by dry heat press, and therefore hardly displaced with respect to the electrode in a process for production of a battery, so that the battery production yield can be improved.

In addition, the separator of the first embodiment is excellent in adhering to the electrode by dry heat press, and maintains a favorable adhering state after being immersed in an electrolytic solution, so that the cycle characteristic (capacity retention ratio) of the battery can be improved.

While the reason for this is not clear, it is supposed that the polarity originating from an acrylic group in the acrylic type monomer considerably influences adhesion. It is supposed that the styrene type monomer has a small polarity, and therefore has an effect of suppressing dissolution and swelling in the electrolytic solution. It is supposed that, by the combination thereof, adhesiveness to the electrode by dry heart press can be improved, and even when the separator is immersed in the electrolytic solution after being adhered by dry heat press, excessive swelling of the adhesive porous layer can be suppressed, so that favorable adhering state to the electrode is maintained. In addition, such an acrylic type resin has high affinity with a polyvinylidene fluoride type resin, and thus both the resins can be uniformly dissolved in a solvent, so that a uniform adhesive porous layer is easily formed. It is considered that the adhesive porous layer contains the acrylic type resin and the polyvinylidene fluoride type resin at a specific composition ratio, and both the resins are uniformly dispersed at a molecular level, so that the separator and the electrode are uniformly adhered to each other, leading to contribution to improvement of the cycle characteristic of the battery.

Hereinafter, details of the porous substrate and the adhesive porous layer of the separator of the first embodiment will be described.

[Porous Substrate]

The separator of the first embodiment includes a porous substrate. Here, since the separator of the second embodiment also includes a porous substrate, hereinafter the porous substrate in the first embodiment and the porous substrate in the second embodiment will be collectively described simply as a “porous substrate”.

In the present disclosure, the porous substrate means a substrate having voids or gaps therein. The porous substrate is, for example, a micro-porous membrane; a porous sheet made of a fibrous material such as a non-woven fabric or paper; or a composite porous sheet in which one or more other porous layers are layered on a micro-porous membrane or a porous sheet. The porous substrate is preferably a micro-porous membrane from the viewpoint of thinning and strength of the separator. The micro-porous membrane means a membrane which has many micro-pores therein and has a structure in which micro-pores are mutually connected so that a gas or liquid can pass from one surface to the other.

The material of the porous substrate is preferably a material having electrical insulation and may be either an organic material and/or an inorganic material.

The porous substrate preferably contains a thermoplastic resin from the viewpoint of applying a shutdown function to the porous substrate. The term “shutdown function” refers to the following function: in a case in which the battery temperature increases, the composition material melts and blocks the pores of the porous substrate, thereby blocking the movement of ions to suppress the thermal runaway of the battery. The thermoplastic resin is preferably a thermoplastic resin having a melting point of less than 200° C. Examples of the thermoplastic resin include polyesters such as polyethylene terephthalate; and polyolefins such as polyethylene and polypropylene, and among them, polyolefins are preferable.

The porous substrate is preferably a micro-porous membrane containing polyolefin (referred herein as to “micro-porous polyolefin membrane”). Examples of the micro-porous polyolefin membrane include micro-porous polyolefin membranes that are applied to conventional battery separators, and it is preferable that one having sufficient dynamic characteristics and ion permeability is selected from these micro-porous polyolefin membranes.

Preferably, the micro-porous polyolefin membrane contains polyethylene from the viewpoint of exhibiting a shutdown function. The content of polyethylene is preferably 95% by mass or more with respect to the total mass of the micro-porous polyolefin membrane.

The micro-porous polyolefin membrane is preferably a micro-porous polyolefin membrane containing polyethylene and polypropylene from the viewpoint of applying heat resistance at a level in which the membrane is not easily broken when being exposed to high temperatures. The micro-porous polyolefin membrane is, for example, a micro-porous membrane existing polyethylene and polypropylene in one layer. The micro-porous membrane preferably contains 95% by mass or more of polyethylene and 5% by mass or less of polypropylene from the viewpoint of achieving both the shutdown function and heat resistance. Further, from the viewpoint of achieving both the shutdown function and heat resistance, the micro-porous polyolefin membrane preferably has a two or more layered structure, and also preferably has a structure in which at least one layer contains polyethylene and at least one layer contains polypropylene.

The weight average molecular weight (Mw) of polyolefin contained in the micro-porous polyolefin membrane is preferably from 100,000 to 5,000,000. When the Mw of the polyolefin is 100,000 or more, it is possible to ensure favorable dynamic characteristics. Meanwhile, when the Mw of the polyolefin is 5,000,000 or less, shutdown characteristics are favorable and it is easy to mold a membrane.

Examples of the method of producing a micro-porous polyolefin membrane include a method of forming a micro-porous membrane including: extruding a molten polyolefin resin from a T-die to form the resin into a sheet; crystallizing the sheet; stretching the resulting sheet; and heat-treating the sheet or a method of forming a micro-porous membrane including: extruding a polyolefin resin molten together with a plasticizer such as liquid paraffin from a T-die; cooling the extruded resin to form into a sheet; stretching the sheet; extracting the plasticizer; and heat-treating the resulting sheet.

Examples of the porous sheet made of a fibrous material include a porous sheet of non-woven fabrics or paper, which are made of fibrous materials such as polyester (e.g., polyethylene terephthalate); polyolefin (e.g., polyethylene and polypropylene); and a heat resistant resin (e.g., aromatic polyamide, polyimide, polyether sulfone, polysulfone, polyether ketone and polyether imide). The heat resistant resin means a resin having a melting point of 200° C. or more or a resin not having a melting point but having a decomposition temperature of 200° C. or more.

The composite porous sheet is, for example, a sheet in which a functional layer is layered on a porous sheet formed of a micro-porous membrane or fibrous material. The composite porous sheet is preferred in terms of the fact that another function can be added by the functional layer. For example, from the viewpoint of giving heat resistance, the functional layer may be a porous layer containing a heat resistant resin or a porous layer containing a heat resistant resin and an inorganic filler. Examples of the heat resistant resin include one or two or more kinds of the heat resistant resins selected from aromatic polyamide, polyimide, polyether sulfone, polysulfone, polyether ketone, or polyether imide. Examples of the inorganic filler include metal oxides such as alumina; and metal hydroxides such as magnesium hydroxide. Examples of the method of forming the composite porous sheet include a method of applying the functional layer to the micro-porous membrane or the porous sheet, a method of adhering the functional layer to the micro-porous membrane or the porous sheet using an adhesive agent, and a method of adhering the functional layer to the micro-porous membrane or the porous sheet by thermal compression.

In order to improve wettability with a coating liquid for forming a porous layer, a surface of the porous substrate may be subjected to various kinds of surface treatments as long as the properties of the porous substrate are not impaired. Examples of the surface treatment include a corona treatment, a plasma treatment, a flame treatment and an ultraviolet ray irradiation treatment.

[Characteristics of Porous Substrate]

In the present disclosure, the thickness of the porous substrate is preferably from 5 ∥m to 25 μm from the viewpoint of obtaining favorable dynamic characteristics and internal resistance.

The Gurley value of the porous substrate (JIS P8117: 2009) is preferably in a range of from 50 sec/100 cc to 300 sec/100 cc from the viewpoint of suppressing the short circuit of the battery and obtaining sufficient ion permeability.

The porosity of the porous substrate is preferably from 20% to 60% from the viewpoint of obtaining suitable membrane resistance and a suitable shutdown function. The porosity of the porous substrate and the separator is determined in accordance with the following calculation method. Where constituent materials are a, b, c, n; the masses of each of the constituent materials are Wa, Wb, Wc, . . . , Wn (g/cm²); the true densities of each of the constituent materials are da, db, dc, . . . , dn (g/cm³), and the thickness is t (cm), the porosity ε (%) is determined by the following formula.

ε{1−(Wa/da+Wb/db+Wc/dc+ . . . +Wn/dn)/t}×100

The puncture strength of the porous substrate is preferably 300 g or more from the viewpoint of improving the separator production yield and the battery production yield. The puncture strength of the porous substrate is a maximum puncture load (g) measured by conducting a puncture test under the condition of a needle tip curvature of 0.5 mm and a puncture speed of 2 mm/sec by using a KES-G 5 handy compression tester manufactured by Kato Tech Co., Ltd.

[Adhesive Porous Layer in First Embodiment]

In the first embodiment, the adhesive porous layer is a layer that is provided as an outermost layer of a separator on one side or both sides of a porous substrate, and adhered to an electrode at the time when the separator and the electrode are superposed on each other, and pressed or hot-pressed.

In the first embodiment, the adhesive porous layer has a large number of micropores therein, with the micropores being linked together, and allows a gas or liquid to pass from one surface to the other surface. In addition, the adhesive porous layer has a porous structure including an acrylic type resin and a polyvinylidene fluoride type resin in a mixed state. The porous structure is one in which an acrylic type resin and a polyvinylidene fluoride type resin form fibril-like bodies while being made compatible or uniformly mixed with each other at a molecular level, and a large number of such fibril-like bodies are integrally connected together to form a three-dimensional network structure. The porous structure can be observed by, for example, a scanning electron microscope (SEM) or the like.

Preferably, the adhesive porous layer exists on not only one surface, but on both surfaces of the porous substrate for the battery to have an excellent cycle characteristic. When the adhesive porous layer exists on both surfaces of the porous substrate, both surfaces of the separator are well adhered to both electrodes with the adhesive porous layer interposed therebetween. In the first embodiment, the adhesive porous layer may further contain a resin other than the acrylic type resin and the polyvinylidene fluoride type resin, an inorganic filler, an organic filler and the like as long as the effect of the invention is not hindered.

(Polyvinylidene Fluoride type Resin in First Embodiment)

In the first embodiment, examples of the polyvinylidene fluoride type resin contained in the adhesive porous layer include homopolymers of vinylidene fluoride (i.e. polyvinylidene fluoride); copolymers of vinylidene fluoride and other copolymerizable monomer (polyvinylidene fluoride copolymers); and mixtures thereof. Examples of the monomer polymerizable with vinylidene fluoride include tetrafluoroethylene, hexafluoropropylene, trifluoroethylene, chlorotrifluoroethylene, vinyl fluoride, and trichloroethylene, and one or two thereof can be used. Among them, a VDF-HFP copolymer is preferable from the viewpoint of adhesiveness to an electrode. As used herein, the “VDF” means a vinylidene fluoride monomer component, the “HFP” means a hexafluoropropylene monomer component, and the “VDF-HFP copolymer” means a polyvinylidene fluoride type resin having a VDF monomer component and a HFP monomer component. By copolymerizing hexafluoropropylene with vinylidene fluoride, crystallinity, heat resistance, resistance to dissolution in an electrolytic solution and the like of the polyvinylidene fluoride type resin can be each controlled to fall within an appropriate range.

For the following reasons, it is preferable that in the separator of the first embodiment, the adhesive porous layer contains a specific VDF-HFP copolymer having a HFP monomer component content of from 3% by mass to 20% by mass with respect to the total amount of all monomer components, and having a weight average molecular weight (Mw) of from 100,000 to 1,500,000. In addition, the VDF-HFP copolymer is also preferable because it has high affinity with the acrylic type resin.

When the HFP monomer component content of the VDF-HFP copolymer is 3% by mass or more, the mobility of a polymer chain when dry heat press is performed is high, and the polymer chain enters irregularities of an electrode surface to exhibit an anchor effect, so that adhesiveness of the adhesive porous layer to the electrode can be improved. From this viewpoint, the HFP monomer component content of the VDF-HFP copolymer is preferably 3% by mass or more, more preferably 5% by mass or more, still more preferably 6% by mass or more.

When the HFP monomer component content of the VDF-HFP copolymer is 20% by mass or less, the copolymer is hardly dissolved and is not excessively swollen in the electrolytic solution, and therefore adhesiveness of the electrode and the adhesive porous layer can be maintained in the battery. From this viewpoint, the HFP monomer component content of the VDF-HFP copolymer is preferably 20% by mass or less, more preferably 18% by mass or less, still more preferably 15% by mass or less.

When the weight average molecular weight (Mw) of the VDF-HFP copolymer is 100,000 or more, the adhesive porous layer can secure such dynamic characteristics that the adhesive porous layer can endure a adhering treatment to the electrode, leading to improvement of adhesiveness to the electrode. In addition, when the weight average molecular weight (Mw) of the VDF-HFP copolymer is 100,000 or more, the copolymer is hardly dissolved in the electrolytic solution, and therefore adhesiveness of the electrode and the adhesive porous layer is easily maintained in the battery. From these viewpoints, the weight average molecular weight (Mw) of the VDF-HFP copolymer is preferably 100,000 or more, more preferably 200,000 or more, still more preferably 300,000 or more, still more preferably 500,000 or more.

When the weight average molecular weight (Mw) of the VDF-HFP copolymer is 1,500,000 or less, the viscosity of a coating liquid used for coating molding of the adhesive porous layer is not excessively high, favorable moldability and crystal formation are secured, and uniformity of surface properties of the adhesive porous layer is high, resulting in favorable adhesiveness of the adhesive porous layer to the electrode. In addition, when the weight average molecular weight (Mw) of the VDF-HFP copolymer is 1,500,000 or less, the mobility of a polymer chain when dry heat press is performed is high, and the polymer chain enters irregularities of an electrode surface to exhibit an anchor effect, so that adhesiveness of the adhesive porous layer to the electrode can be improved. From these viewpoints, the weight average molecular weight (Mw) of the VDF-HFP copolymer is preferably 1,500,000 or less, more preferably 1,200,000 or less, still more preferably 1,000,000 or less.

Examples of the method of producing PVDF or a VDF-HFP copolymer include emulsion polymerization and suspension polymerization. In addition, it is also possible to select a commercially available VDF-HFP copolymer that satisfies the HFP unit content and the weight average molecular weight.

(Acrylic Type Resin in First Embodiment)

In the separator of the first embodiment, the adhesive porous layer contains an acrylic type resin in addition to the polyvinylidene fluoride type resin. It is important that the acrylic type resin is a copolymer containing an acrylic type monomer and a styrene type monomer as monomer components.

The acrylic type monomer that forms the acrylic type resin includes at least one selected from the group consisting of an acrylic acid, an acrylic acid salt, an acrylic acid ester, a methacrylic acid, a methacrylic acid salt and a methacrylic acid ester. Examples of the acrylic acid salt include sodium acrylate, potassium acrylate, magnesium acrylate and zinc acrylate. Examples of the acrylic acid ester include methyl acrylate, ethyl acrylate, isopropyl acrylate, butyl acrylate, 2-ethylhexyl acrylate, 2-hydroxyethyl acrylate, hydroxypropyl acrylate, methoxypolyethylene glycol acrylate, isobomyl acrylate, dicyclopentanyl acrylate, cyclohexyl acrylate, 4-hydroxybutyl acrylate and polymethoxydiethylene glycol (meth)acrylate. Examples of the mathacrylic acid salt include sodium methacrylate, potassium methacrylate, magnesium methacrylate and zinc methacrylate. Examples of the methacrylic acid ester include methyl methacrylate, ethyl methacrylate, isopropyl methacrylate, butyl methacrylate, isobutyl methacrylate, n-hexyl methacrylate, cyclohexyl methacrylate, lauryl methacrylate, 2-hydroxyethyl methacrylate, hydroxypropyl methacrylate, diethylaminoethyl methacrylate, methoxypolyethylene glycol methacrylate, isobomyl methacrylate, dicyclopentanyl methacrylate, cyclohexyl methacrylate and 4-hydroxybutyl methacrylate.

Among them, methyl methacrylate, ethyl methacrylate, isopropyl methacrylate, butyl methacrylate, methyl acrylate, ethyl acrylate, isopropyl acrylate, butyl acrylate, 2-hydroxyethyl acrylate, 2-hydroxyethyl methacrylate and polymethoxydiethylene glycol (meth)acrylate are preferable as the acrylic type monomer, and in particular, methyl methacrylate, which is excellent in compatibility with the polyvinylidene fluoride type resin is most preferable because methyl methacrylate has an effect of reducing the glass transition temperature of the adhesive porous layer.

The acrylic type resin may be a terpolymer containing, as monomer components, two acrylic type monomers selected from the group consisting of 2-hydroxyethyl methacrylate, ethyl acrylate, butyl acrylate, methyl methacrylate and polymethoxydiethylene glycol (meth)acrylate, and a styrene type monomer

When the acrylic type resin is a terpolymer, mention is made of two selected from the group consisting of 2-hydroxyethyl methacrylate, ethyl acrylate, butyl acrylate, methyl methacrylate and polymethoxydiethylene glycol (meth)acrylate, and a styrene type monomer as the acrylic type monomer that forms the acrylic type resin.

As the acrylic type monomer when the acrylic type resin is a terpolymer, two selected from the group consisting of methyl methacrylate, polymethoxydiethylene glycol (meth)acrylate and butyl acrylate are preferable among the above-mentioned monomers, and in particular, it is most preferable that methyl methacrylate, which is excellent in compatibility with the polyvinylidene fluoride type resin, is contained because methyl methacrylate has an effect of reducing the glass transition temperature of the adhesive porous layer.

The acrylic resin in the first embodiment contains a styrene type monomer as a constituent component, and is therefore often partially compatible with the polyvinylidene fluoride type resin. In this partial compatibility, the glass transition temperature is reduced only at a compatible part, and the glass transition temperature of an incompatible part may remain high before and after blending. Here, it is preferable to use two acryl monomers because adhesive strength is secured, and the glass transition temperature at the incompatible part can be reduced.

Examples of the styrene type monomer that forms the acrylic type resin may include styrene, meta-chlorostyrene, para-chlorostene, para-fluorostyrene, para-methoxystyrene, meta-tertiary-butoxysene, para-tertiary-butoxystyrene, para-vinylbenzoic acid, and para-methyl-α-methylstyrene.

Among them, styrene, para-methoxy-styrene and para-methyl-α-methylstyrene are preferable as the styrene type monomer, and in particular, styrene is most preferable because styrene has a strong effect of suppressing dissolution and swelling in an electrolytic solution.

In the separator of the present disclosure, the copolymerization ratio of the acrylic type monomer to the styrene type monomer (acrylic type monomer/styrene type monomer [mass ratio]) is preferably in a range of from 0.10 to 2.35, more preferably from 0.15 to 1.50, and most preferably from 0.20 to 1.00 from the viewpoint of further improving the effect of the invention. It is preferable that the copolymerization ratio of the acrylic type monomer to the styrene type monomer is 2.35 or less because the separator is hardly peeled even when immersed in an electrolytic solution. It is preferable that the copolymerization ratio of the acrylic type monomer to the styrene type monomer is 0.10 or more because adhesive strength is easily improved at the time of performing dry heat press.

The acrylic type resin to be used in the adhesive porous layer of the separator of the present disclosure may contain an unsaturated carboxylic anhydride in addition to the acrylic type monomer and the styrene type monomer as monomer components.

Examples of the unsaturated carboxylic anhydride may include maleic anhydride, itaconic anhydride, citraconic anhydride, 4-methacryloxyethyltrimellitic anhydride, and trimellitic anhydride.

The unsaturated carboxylic anhydride contained in the acrylic type resin is 50% by mass or less, more preferably 40% by mass or less, most preferably 30% by mass or less with respect to the total amount of the acrylic type resin. When the amount of the unsaturated carboxylic anhydride is 50% by mass or less with respect to the total amount of the acrylic type resin, the glass transition temperature of the acrylic type resin does not exceed 150° C., and it is possible to firmly adhered the separator to the electrode by dry heat press. The content of the unsaturated carboxylic anhydride contained in the acrylic type resin is preferably 1.0% by mass or more with respect to the total amount of the acrylic type resin from the viewpoint of adhesiveness. From this viewpoint, the content of the unsaturated carboxylic anhydride is more preferably 5% by mass or more, especially preferably 10% by mass or more.

Addition of the unsaturated carboxylic anhydride tends to increase the glass transition temperature of the acrylic type resin, but the separator can be firmly adhered to the electrode by dry heat press. While the reason for this is not clear, it is considered that an acid anhydride skeleton may have a high polarity, resulting in formation of a strong intermolecular interaction with the electrode, or the acid anhydride skeleton may react with a resin component in the electrode.

The glass transition temperature of the acrylic type resin to be used in the separator of the first embodiment is preferably in a range of from −20° C. to 150° C. Generally, as the glass transition temperature of the acrylic type resin decreases, the fluidity of the adhesive porous layer is increased in dry heat press, and therefore the polymer chain enters irregularities of an electrode surface to exhibit an anchor effect, so that adhesiveness of the adhesive porous layer to the electrode is improved. Even an acrylic resin having a high glass transition temperature may exhibit high adhesive strength because the glass transition temperature of the adhesive porous layer substantially decreases when the acrylic resin is compatible, e.g. completely or partially compatible, with the vinylidene fluoride type resin. The glass transition temperature is preferably −20° C. or higher because the adhesive porous layer situated on a separator surface hardly causes blocking. The glass transition temperature is preferably 150° C. or lower because the effect of adhesiveness by dry heat press is easily improved.

The weight average molecular weight (Mw) of the acrylic type resin to be used in the separator of the first embodiment is preferably from 10,000 to 500,000. The Mw of the acrylic type resin is preferably 10,000 or more because adhesive strength to the electrode by dry heat press is improved. The Mw of the acrylic type resin is 500,000 or less because the adhesive porous layer has favorable fluidity in dry heat press. The Mw of the acrylic type resin is more preferably in a range of from 30,000 to 300,000, most preferably in a range of from 50,000 to 200,000.

From the viewpoint of exhibiting the effect of the invention and increasing peeling strength between the porous substrate and the adhesive porous layer, the content of the acrylic type resin in the adhesive porous layer is preferably 2% by mass or more, more preferably 7% by mass or more, still more preferably 10% by mass or more, still more preferably 15% by mass or more with respect to the total amount of all the resins contained in the adhesive porous layer. From the viewpoint of suppressing cohesive fracture of the adhesive porous layer, the content of the acrylic type resin in the adhesive porous layer is preferably 40% by mass or less, more preferably 38% by mass or less, still more preferably 35% by mass or less, still more preferably 30% by mass or less with respect to the total amount of all the resins contained in the adhesive porous layer.

(Other Resins in First Embodiment)

In the first embodiment, the adhesive porous layer may contain other resins in addition to the vinylidene fluoride resin and the acrylic type resin.

Examples of other resins include fluorine-based rubber, styrene-butadiene copolymers, homopolymers or copolymers of vinylnitrile compounds (acrylonitrile, methacrylonitrile and the like), carboxymethyl cellulose, hydroxyalkyl cellulose, polyvinyl alcohol, polyvinyl butyral, polyvinyl pyrrolidone, and polyethers (polyethylene oxide, polypropylene oxide and the like).

(Filler in First Embodiment)

In the first embodiment, the adhesive porous layer may contain a filler composed of an inorganic substance or an organic substance for the purpose of improving the sliding properties and heat resistance of the separator. In that case, it is preferable to set a content and a particle size so as not to hinder the effect of the first embodiment. From the viewpoint of improving cell strength and securing the safety of the battery, the filler is preferably an inorganic filler.

The average particle size of the filler is preferably from 0.01 μm to 5 μm. The lower limit thereof is more preferably 0.1 μm or more, and the upper limit thereof is more preferably 1 μm or less.

The inorganic filler is preferably one that is stable to an electrolytic solution and that is electrochemically stable. Specific examples of the inorganic filler include metal hydroxides such as aluminum hydroxide, magnesium hydroxide, calcium hydroxide, chromium hydroxide, zirconium hydroxide, cerium hydroxide, nickel hydroxide and boron hydroxide; metal oxides such as alumina, titania, magnesia, silica, zirconia and barium titanate; carbonates such as calcium carbonate and magnesium carbonate; sulfates such as barium sulfate and calcium sulfate: and clay minerals such as calcium silicate and talc. The inorganic filler may be used singly, or in combination of two or more kinds thereof. The inorganic filler may be one which is surface-modified with a silane coupling agent.

The inorganic filler is preferably at least one of a metal hydroxide or a metal oxide from the viewpoint of securing stability in the battery and the safety of the battery, and from the viewpoint of the electricity eliminating effect and impartment of flame retardancy, a metal hydroxide is preferable, and magnesium hydroxide is more preferable.

The particle shape of the inorganic filler is not limited, and may be a shape close to a sphere or a plate shape, but from the viewpoint of suppressing a short-circuit of the battery, plate-shaped particles and primary particles that are not aggregated are preferable.

When the adhesive porous layer contains an inorganic filler, the content of the inorganic filler in the adhesive porous layer is preferably from 5% by mass to 80% by mass with respect to the total amount of all the resins and the inorganic filler contained in the adhesive porous layer. The content of the inorganic filler is preferably 5% by mass or more from the viewpoint of dimensional stability because thermal shrinkage of the separator is suppressed in application of heat. From this viewpoint, the content of the inorganic filler is more preferably 10% by mass or more, still more preferably 20% by mass or more. The content of the inorganic filler is preferably 80% by mass or less because adhesiveness of the adhesive porous layer to the electrode is secured. From this viewpoint, the content of the inorganic tiller is more preferably 80% by mass or less, still more preferably 75% by mass or less.

Examples of the mimic filler include crosslinked acrylic resins such as crosslinked polymethyl methacrylate, crosslinked polystyrene, and crosslinked urethane resins, and crosslinked polymethyl methacrylate is preferable.

(Other Components in First Embodiment)

In the first embodiment, the adhesive porous layer may contain additives such as a dispersant such as a surfactant, a wetting agent, a defoaming agent, and a pH adjusting agent. For the purpose of improving dispersibility, coatability and the storage stability, the dispersant is added to a coating liquid to be used for the coating molding of the adhesive porous layer. For the purpose of, for example, improving compatibility with the porous substrate, inhibiting air from being caught in the coating liquid, or adjusting pH, the wetting agent, the defoaming agent and the pH adjusting agent are added to the coating liquid to be used for coating molding of the adhesive porous layer.

[Characteristics of Adhesive Porous Layer in First Embodiment]

In the first embodiment, the thickness of the adhesive porous layer at one side of the porous substrate is preferably 0.5 μm or more, more preferably 1.0 μm or more from the viewpoint of adhesiveness to the electrode, and is preferably 8.0 μm or less, more preferably 6.0 μm or less from the viewpoint of the energy density of the battery.

When the adhesive porous layers are provided on both sides of the porous substrate, a difference between the thickness of the adhesive porous layer at one side and the thickness of the adhesive porous layer at the other side is preferably 20% or less with respect to the total thickness at both sides, and the difference is preferably as low as possible.

The weight of the adhesive porous layer at one side of the porous substrate is preferably 0.5 g/m² or more, more preferably 0.75 g/m² or more from the viewpoint of adhesiveness to the electrode, and is preferably 5.0 g/m² or less, more preferably 4.0 g/m² or less from the viewpoint of ion permeability.

The porosity of the adhesive porous layer is preferably 30% or more from the viewpoint of ion permeability, and is preferably 80% or less, more preferably 60% or less from the viewpoint of dynamic strength. The method of determining the porosity of the adhesive porous layer in the first embodiment is the same as the method of determining the porosity of the porous substrate.

The average pore size of the adhesive porous layer is preferably 10 nm or more from the viewpoint of ion permeability, and is preferably 200 nm or less from the viewpoint of adhesiveness to the electrode. The average pore size of the adhesive porous layer in the first embodiment is calculated from the following formula with respect to the assumption that all the pores are cylindrical.

d=4V/S

In the formula, d represents an average pore size (diameter) of the adhesive porous layer, V represents a pore volume per 1 m² of the adhesive porous layer, and S represents a pore surface area per 1 m² of the adhesive porous layer.

The pore volume V per 1 m² of the adhesive porous layer is calculated from the porosity of the adhesive porous layer. The pore surface area S per 1 m² of the adhesive porous layer is determined by the following method.

First, a specific surface area (m²/g) of the porous substrate and a specific surface area (m²/g) of the separator are calculated from a nitrogen gas adsorption amount by applying the BET equation to a nitrogen gas adsorption method. The specific surface areas (m²/g) are multiplied by respective basis weights (g/m²) to calculate respective pore surface areas per 1 m². The pore surface area per 1 m² of the porous substrate is subtracted from the pore surface area per 1 m² of the separator to calculate the pore surface area S per 1 m² of the adhesive porous layer.

The peeling strength between the porous substrate and the adhesive porous layer is preferably 0.20 N/10 mm or more. When the peeling strength is 0.20 N/10 mm or more, the separator has excellent handling characteristics in a process for production of a battery. From this viewpoint, the peeling strength is more preferably 0.30 N/10 mm or more, and is preferably as high as possible. The upper limit of the peel strength is not limited, but is normally 2.0N/10 mm or less.

[Characteristics of Separator of First Embodiment]

The thickness of the separator of the first embodiment is preferably 5 μm or more from the viewpoint of mechanical strength, and is preferably 35 μm or less from the viewpoint of energy density of the battery.

The puncture strength of the separator of the first embodiment is preferably from 250 g to 1,000 g, more preferably from 300 g to 600 g. The method of measuring the puncture strength of the separator is the same as the method of measuring the puncture strength of the porous substrate.

The porosity of the separator of the first embodiment is preferably from 30% to 65%, more preferably from 30% to 60% from the viewpoints of adhesiveness to the electrode, handling characteristics, ion permeability, and mechanical strength.

The Gurley value (JIS P 8117: 2009) of the separator of the first embodiment is preferably 100 sec/100 cc to 300 sec/100 cc from the viewpoint of mechanical strength and the load characteristics of the battery.

<Separator for a Non-Aqueous Secondary Battery of Second Embodiment>

A separator for a non-aqueous secondary battery (also referred to as a “separator”) of the second embodiment includes a porous substrate, and an adhesive porous layer provided on one side or both sides of the porous substrate.

In the separator of the second embodiment, the adhesive porous layer has a porous structure including an acrylic type resin and a polyvinylidene fluoride type resin in a mixed state. The adhesive porous layer contains the acrylic type resin in an amount of from 2 to 40% by mass with respect to a total mass of the acrylic type resin and the polyvinylidene fluoride type resin. It is important that the acrylic type resin is a copolymer containing, as monomer components, a first monoacrylate type monomer, and a second monoacrylate type monomer that has an oxyalkylene structural unit with a repetition number of from 2 to 10,000.

The separator of the second embodiment is excellent in adhesiveness to an electrode by dry heat press, and therefore hardly displaced with respect to the electrode in a process for production of a battery, so that the battery production yield can be improved.

In addition, the separator of the second embodiment is excellent in adhesiveness to the electrode by dry heat press, and has a low ion conduction resistance, so that the cycle characteristic (capacity retention ratio) of the battery can be improved.

While the reason for this is not clear, it is supposed that the polarity originating from acrylic groups in the first and second monoacrylate type monomers that form the acrylic type resin considerably influences adhesiveness. The second monoacrylate type monomer has a repeating structural unit of an oxyalkylene which exhibits excellent ion conductivity in the molecular structure thereof. It is supposed that by combination of the above-mentioned properties, adhesiveness to the electrode by dry heat press can be improved, low ion conduction resistance is attained, and the cycle characteristic of the battery is improved.

In addition, such an acrylic type resin has high affinity with a polyvinylidene fluoride type resin, and thus both the resins can be uniformly dissolved in a solvent, so that a uniform adhesive porous layer is easily formed. It is considered that the adhesive porous layer contains the acrylic type resin and the polyvinylidene fluoride type resin at a specific composition ratio, and both the resins are uniformly dispersed at a molecular level, so that the separator and the electrode are uniformly adhered to each other, leading to contribution to improvement of the cycle characteristic of the battery.

Hereinafter, details of the porous substrate and the adhesive porous layer of the separator of the second embodiment will be described.

[Porous Substrate]

The separator of the second embodiment includes a porous substrate. As the porous substrate in the separator of the second embodiment, the porous substrate described in connection with the separator of the first embodiment can be used, and the same applies for preferred ranges and characteristics.

[Adhesive Porous Layer in Second Embodiment]

In the second embodiment, the adhesive porous layer is a layer that is provided as an outermost layer of a separator on one side or both sides of a porous substrate, and adhered to an electrode at the time when the separator and the electrode are superposed on each other, and pressed or hot-pressed. The porous structure of the adhesive porous layer of the second embodiment may be the same as those explained in the first embodiment so that the repetitive explanation herein is omitted. In addition, the preferable configuration of the adhesive porous layer of the second embodiment with respect to the porous substrate may be the same as those explained in the first embodiment so that the repetitive explanation herein is omitted. Furthermore, in the second embodiment, the adhesive porous layer may further contain other components as long as the effect of the invention is not hindered, and the other components to be used in the second embodiment may be the same as those explained in the first embodiment so that the repetitive explanation herein is omitted.

(Polyvinylidene Fluoride type Resin in Second Embodiment)

In the second embodiment, examples of the polyvinylidene fluoride type resin contained in the adhesive porous layer may be the same as the polyvinylidene fluoride type resin explained in the first embodiment. Further, the preferable HFP monomer component and VDF-HFP copolymer and preferred ranges thereof are also the same as those explained in the first embodiment so that the repetitive explanations herein are omitted.

(Acrylic type resin in Second Embodiment)

In the separator of the second embodiment, the adhesive porous layer contains an acrylic type resin in addition to the polyvinylidene fluoride type resin. It is important that the acrylic type resin is a copolymer containing, as monomer components, a first monoacrylate type monomer, and a second monoacrylate type monomer having an oxyalkylene structural unit with a repetition number of 2 to 10,000.

Preferably, the first monoacrylic type monomer that forms the acrylic type resin has a structural unit of at least one selected from the group consisting of an acrylic acid, an acrylic acid salt, an acrylic acid ester, a methacrylic acid, a methacrylic acid salt and a methacrylic acid ester. Examples of the acrylic acid salt include sodium acrylate, potassium acrylate, magnesium acrylate and zinc acrylate. Examples of the acrylic acid ester include methyl acrylate, ethyl acrylate, isopropyl acrylate, n-butyl acrylate, 2-ethylhexvl acrylate, 2-hydroxyethyl acrylate, hydroxypropyl acrylate, methoxypolyethylene glycol acrylate, isobomyl acrylate, dicyclopentanyl acrylate, cyclohexyl acrylate and 4-hydroxybutyl acrylate. Examples of the mathacrylic acid salt include sodium methacrylate, potassium methacrylate, magnesium methacrylate and zinc methacrylate. Examples of the methacrylic acid ester include methyl methacrylate, ethyl methacrylate, isopropyl methacrylate, butyl methacrylate, isobutyl methacrylate, n-hexyl methacrylate, cyclohexyl methacrylate, lauryl methacrylate, 2-hydroxyethyl methacrylate, hydroxypropyl methacrylate, diethvlaminoethyl methacrylate, methoxypolyethylene glycol methacrylate, isobornyl methacrylate, dicyclopentanyl methacrylate, cyclohexyl methacrylate and 4-hydroxybutyl methacrylate.

Among them, methyl methacrylate, ethyl methacrylate, isopropyl methacrylate, butyl methacrylate, methyl acrylate, ethyl acrylate, isopropyl acrylate, n-butyl acrylate, 2-hydroxyethyl acrylate and 2-hydroxyethyl methacrylate are preferable as the first monoacrylic type monomer, and in particular, methyl methacrylate, which is excellent in compatibility with the polyvinylidene fluoride type resin is most preferable because methyl methacrylate has an effect of reducing the glass transition temperature of the adhesive porous layer.

The second monoacrylic type monomer that forms the acrylic type resin is not limited as long as it is a monoacrylic type monomer having an oxyalkylene structural unit with a repetition number of 2 to 10,000, and examples thereof may include ethoxydiethylene glycol monoacrylate, methoxytriethylene glycol monoacrylate, 2-ethylhexyl diglycol monoacrylate, methoxypolyethylene glycol monoacrylate (the repetition number (n) of ethylene glycols is from 4 to 10,000), methoxydipropylene glycol monoacrylate, phenoxydiethylene glycol monoacrylate, phenoxypolyethylene glycol monoacrylate (n=3 to 10,000), ethoxydiethylene glycol monomethacrylate, methoxytriethylene glycol monomethacrylate, 2-ethythexyl diglycol monomethacrylate, methoxypolyethylene glycol monomethacrylate (the repetition number (n) of ethylene glycols is from 4 to 10,000), methoxydipropylene glycol monomethacrylate, phenoxydiethylene glycol monomethacrylate, and phenoxypolyethylene glycol monomethacrylate (n=3 to 10,000).

In the separator of the second embodiment, the ratio of the second monoacrylate type monomer in the acrylic type resin is preferably in a range of from 30 to 95% by mass, more preferably from 35 to 80% by mass, most preferably from 40 to 70% by mass from the viewpoint of further improving the effect of the invention. The ratio of the second monoacrylate type monomer is preferably 95% by mass or less because high adhesive strength with the electrode can be obtained. The ratio of the second monoacrylate type monomer is preferably 30% by mass or more because the acrylic type resin is hardly dissolved in the electrolytic solution.

The glass transition temperature of the acrylic type resin to be used in the separator of the second embodiment is preferably in a range of from −40° C. to 120° C. Generally, as the glass transition temperature of the acrylic type resin decreases, the fluidity of the adhesive porous layer is increased in dry heat press, and therefore the polymer chain enters irregularities of an electrode surface to exhibit an anchor effect, so that adhesiveness of the adhesive porous layer to the electrode is improved. Even an acrylic resin having a high glass transition temperature may exhibit high adhesive strength because the glass transition temperature of the adhesive porous layer substantially decreases when the acrylic resin is compatible, e.g. completely or partially compatible, with the vinylidene fluoride type resin. The glass transition temperature is preferably −40° C. or higher because the adhesive porous layer situated on a separator surface hardly causes blocking. The glass transition temperature is preferably 120° C. or lower because the effect of adhesiveness by dry heat press is easily improved.

The acrylic type resin to be used in the separator of the second embodiment is a linear polymer because starting materials thereof include the first monoacrylate type monomer, and the second monoacrylate type monomer having an oxyalkylene structural unit with a repetition number of from 2 to 10,000. The linear polymer is superior in fluidity to, for example, a resin having a crosslinked structure. Therefore, in adhesiveness of the electrode and the separator to each other by dry heat press, the polymer chain enters irregularities of an electrode surface to exhibit an anchor effect, so that adhesiveness of the adhesive porous layer to the electrode can be improved. The acrylic type resin for use in the invention is linear, and therefore it is easy to form a uniform adhesive porous layer in a state of being compatible or uniformly mixed with the polyvinylidene fluoride type resin at a molecular level. It is considered that the adhesive porous layer contains the acrylic type resin and the polyvinylidene fluoride type resin at a specific composition ratio, and both the resins are uniformly dispersed at a molecular level, so that the separator and the electrode are uniformly adhered to each other, leading to contribution to improvement of the cycle characteristic of the battery.

The weight average molecular weight (Mw) of the acrylic type resin to be used in the separator of the second embodiment may be the same as the Mw of the acrylic type resin to be used in the first embodiment, so that the repetitive explanation herein is omitted.

The content of the acrylic type resin in the adhesive porous layer of the second embodiment may be the same as the content of the acrylic type resin in the adhesive porous layer of the first embodiment, so that the repetitive explanation herein is omitted.

(Other Resins in Second Embodiment)

In the second embodiment, the adhesive porous layer may contain other resins in addition to the vinylidene fluoride resin and the acrylic type resin. The other resins to be used in the second embodiment may be the same as the other resins explained in the first embodiment, so that the repetitive explanation herein is omitted.

(Filler in Second Embodiment)

In the second embodiment, the adhesive porous layer may contain a filler composed of an inorganic substance or an organic substance for the purpose of improving the sliding properties and heat resistance of the separator. The filler to be used in the second embodiment may be the same as the filler explained in the first embodiment, so that the repetitive explanation herein is omitted.

(Other Components in Second Embodiment)

In the second embodiment, the adhesive porous layer may contain other components, and the other components to be used in the second embodiment may be the same as the other components explained in the first embodiment, so that the repetitive explanation herein is omitted.

[Characteristics of Adhesive Porous Layer in Second Embodiment]

The characteristics of the adhesive porous layer in the second embodiment are the same as the characteristics of the adhesive porous layer of the first embodiment, so that the repetitive explanation herein is omitted.

[Characteristics of Separator of Second Embodiment]

The characteristics of the separator in the second embodiment are the same as the characteristics of the separator of the first embodiment, so that the repetitive explanation herein is omitted.

[Method of Producing Separator]

The separators of the first and second embodiments can be each produced by, for example, a wet coating method including the following steps (i) to (iii):

(i) coating a porous substrate with a coating liquid containing a vinylidene fluoride type resin and an acrylic type resin, thereby forming a coating layer;

(ii) immersing the porous substrate, which is provided with the coating layer, in a coagulation liquid, and solidifying the polyvinylidene fluoride type resin and the acrylic type resin while inducing phase separation in the coating layer, thereby forming a porous layer on the porous substrate to obtain a composite membrane; and

(iii) washing with water and drying the composite membrane.

The coating liquid is prepared by dissolving or dispersing the polyvinylidene fluoride type resin and the acrylic type resin in a solvent. When a filler is included in the adhesive porous layer, the filler is dispersed in the coating liquid.

The solvent to be used in preparation of the coating liquid is a solvent capable of dissolving a polyvinylidene fluoride type resin (hereinafter also referred to as a “good solvent”). Examples of the good solvent include polar amide solvents such as N-methylpyrrolidone, dimethylacetamide and dimethylformamide.

Preferably, the solvent to be used for preparation of the coating liquid contains a phase separation agent that induces phase separation from the viewpoint of forming a porous layer having a favorable porous structure. Thus, the solvent to be used for preparation of the coating liquid is preferably a mixed solvent of a good solvent and a phase separation agent. Preferably, the phase separation agent is mixed with a good solvent in an amount in a range which ensures that a viscosity suitable for coating can be secured. Examples of the phase separation agent include water, methanol, ethanol, propyl alcohol, butyl alcohol, butanediol, ethylene glycol, propylene glycol and tripropylene glycol.

The solvent to be used for preparation of the coating liquid is preferably a mixed solvent of a good solvent and a phase separation agent, which contains the good solvent in an amount of 60% by mass or more and the phase separation agent in an amount of 40% by mass or less, from the viewpoint of forming a favorable porous structure.

The resin concentration of the coating liquid is preferably from 1% by mass to 20% by mass from the viewpoint of forming a favorable porous structure.

Examples of means for coating the porous substrate with a coating liquid include a Meyer bar, a die coater, a reverse roll coater and a gravure coater in a case in which the porous layer is formed on both surfaces of the porous substrate, it is preferable to simultaneously coat the both surfaces with the coating liquid from the viewpoint of productivity.

The coagulation liquid may contain only water, but generally contains water, and the good solvent and phase separation agent used for preparation of the coating liquid. From the viewpoint of production, it is preferable that the mixing ratio of the good solvent and the phase separation agent is made consistent with the mixing ratio of the mixed solvent used for preparation of the coating liquid. The content of water in the coagulation liquid is preferably from 40% by mass to 90% by mass from the viewpoint of productivity and formation of a porous structure. The temperature of the coagulation liquid is, for example, from 20° C. to 50° C.

The separator of the present disclosure can also be produced by a dry coating method. The dry coating method is a method in which a porous substrate is coated with a coating liquid containing a resin to form a coating layer, and the coating layer is then dried to solidify the coating layer, whereby a porous layer is formed on the porous substrate. However, in the dry coating method, the porous layer is more easily densified as compared to the wet coating method, and therefore the wet coating method is preferable from the viewpoint of obtaining a favorable porous structure.

The separator of the present disclosure can also be produced by a method in which a porous layer is prepared as an independent sheet, and the porous layer is superimposed on a porous substrate, and laminated thereto by thermocompression adhering or with an adhesive. Examples of the method of preparing a porous layer as an independent sheet include a method in which a porous layer is formed on a release sheet using the wet coating method or dry coating method, and the release sheet is separated from the porous layer.

<Non-aqueous Secondary Battery>

A non-aqueous secondary battery of the present disclosure is a non-aqueous secondary battery which produces an electromotive force by lithium doping and dedoping, the non-aqueous secondary battery including a positive electrode, a negative electrode, and the separator for a non-aqueous secondary battery of the first or second embodiment. The doping means absorption, holding, adsorption or insertion, which means a phenomenon in which lithium ions enter an active material of an electrode such as a positive electrode.

The non-aqueous secondary battery of the present disclosure has, for example, a structure in which a battery element with a negative electrode and a positive electrode facing each other with a separator interposed there between is enclosed in an outer packaging material together with an electrolytic solution. The non-aqueous secondary battery of the present disclosure is suitable as a non-aqueous electrolyte secondary battery, particularly a lithium ion secondary battery.

The production yield of the non-aqueous secondary battery of the present disclosure is high because the separator of the first or second embodiment is excellent in adhesiveness to the electrode by dry heat press.

The non-aqueous secondary battery of the present disclosure is excellent in battery cycle characteristic (capacity retention ratio) because the separator of the first embodiment is firmly adhered to the electrode by dry heat press, and adhesiveness is maintained after subsequent immersion of the separator in the electrolytic solution immersion.

The non-aqueous secondary battery of the present disclosure is excellent in battery cycle characteristic (capacity retention ratio) because the separator of the second embodiment is firmly adhered to the electrode by dry heat press, and low ion conduction resistance is attained owing to the ion-conductive polymer.

Hereinafter, examples of forms of a positive electrode, a negative electrode, an electrolytic solution and an outer packaging material each included in the non-aqueous secondary battery of the present disclosure will be described.

Examples of the embodiment of the positive electrode include a structure in which an active material layer containing a positive electrode active material and a binder resin is disposed on a current collector. The active material layer may further contain a conductive auxiliary agent. Examples of the positive electrode active material include lithium-containing transition metal oxides, specific examples of which include LiCoO₂, LiNiO₂, LiMn_{1/2}Ni_{1/2}O₂, LiCo_{1/3}Mn_{1/3}Ni_{1/3}O₂, LiMn₂O₄, LiFePO₄, LiCo_{1/2}Ni_{1/2}O₂ and LiAl_{1/4}Ni_{3/4}O₂. Examples of the binder resin include polyvinylidene fluoride type resins, and styrene-butadiene copolymers. Examples of the conductive auxiliary agent include carbon materials such as acetylene black, ketjen black and graphite powders. Examples of the current collector include aluminum foils, titanium foils and stainless foils having a thickness of, for example, from 5 μm to 20 μm.

In the non-aqueous secondary battery of the present disclosure, the polyvinylidene fluoride type resin contained in the adhesive porous layer of the separator of the present disclosure is excellent in oxidation resistance, and therefore by disposing the adhesive porous layer on the positive electrode side in the non-aqueous secondary battery, LiMm_{1/2}Ni_{1/2}O₂, LiCo_{1/3}Mn_{1/3}Ni_{1/3}O₂ or the like, which is capable of operating at a high voltage of 4.2V or more, is easily applied as the positive electrode active material.

Examples of the embodiment of the negative electrode include a structure in which an active material layer containing a negative electrode active material and a binder resin is disposed on a current collector. The active material layer may further contain a conductive auxiliary agent. Examples of the negative electrode active material include materials capable of electrochemically absorbing lithium, specific examples of which include carbon materials; alloys of lithium and silicon, tin, aluminum or the like; and wood alloys. Examples of the binder resin include polyvinylidene fluoride type resins, and styrene-butadiene copolymers. Examples of the conductive auxiliary agent include carbon materials such as acetylene black, ketjen black, graphite powders and ultra-thin carbon fibers. Examples of the current collector include copper foils, nickel foils and stainless foils having a thickness of, for example, from 5 μm to 20 μm. In place of the negative electrode described above, a metal lithium foil may be used as a negative electrode.

The electrolytic solution is a solution obtained by dissolving a lithium salt in a non-aqueous solvent. Examples of the lithium salt include LiPF₆, LiBF₄ and LiClO₄. Examples of the non-aqueous solvent include cyclic carbonates such as ethylene carbonate, propylene carbonate, fluoroethylene carbonate, difluoroethylene carbonate and vinylene carbonate; chain carbonates such as dimethyl carbonate, diethyl carbonate, ethylmethyl carbonate and fluorine-substituted products thereof; and cyclic esters such as γ-butyrolactone and γ-valerolactone. They may be used singly, or in combination of two or more kinds thereof. The electrolytic solution is preferably a solution obtained by mixing cyclic carbonate and chain carbonate at a mass ratio (cyclic carbonate:chain carbonate) of 20:80 to 40:60, and dissolving a lithium salt therein in an amount of from 0.5 mol/L to 1.5 mol/L.

Examples of the outer packaging material include metal cans and aluminum laminated film packages. Examples of the shape of the battery include a rectangular shape, a circular-cylindrical shape and a coin shape, and the separator of the present disclosure is suitable for any shape.

examples of the method of producing the non-aqueous secondary battery of the present disclosure include a method in which a separator is adhered to an electrode by performing a heat press treatment (referred to as “dry heat press” in the present disclosure) without impregnating the separator with an electrolytic solution, and the separator is then impregnated with the electrolytic solution. The production method includes, for example, a lamination step of producing a laminated body in which the separator of the present disclosure is disposed between a positive electrode and a negative electrode; a dry adhering step of adhering the electrode and the separator to each other by subjecting the laminated body to dry heat press; and a post step of injecting an electrolytic solution into the laminated body stored in an outer packaging material, and sealing the outer packaging material.

The method of disposing a separator between a positive electrode and a negative electrode in the lamination step may be a method in which at least one positive electrode, separator and negative electrode are layered in this order one on another (so called a stacking method), or a method in which a positive electrode, a separator, a negative electrode and a separator are superimposed one on another in this order, and wound in the length direction.

The dry adhering step may be carried out before the laminated body is stored in the outer packaging material (e.g. a pack made of an aluminum laminate film), or after the laminated body is stored in the outer packaging material. That is, the laminated body in which the electrode and the separator are adhered to each other by dry heat press may be stored in the outer packaging material, or the electrode and the separator may be adhered to each other by performing dry heat press from above the outer packaging material after storage of the laminated body in the outer packaging material.

The pressing temperature in the dry adhering step is preferably from 70° C. to 120° C., more preferably from 75° C. to 110° C., still more preferably from 80° C. to 100° C. When the pressing temperature is in the above-mentioned range, the electrode and the separator are favorably adhered to each other, and the separator can be moderately expanded in a width direction, so that a short-circuit of the battery hardly occurs.

The press pressure in the dry adhering step is preferably from 0.5 kg to 40 kg in terms of a load per 1 cm² of the electrode. Preferably, the pressing time is adjusted according to the pressing temperature and the press pressure. For example, the pressing time is adjusted to fall within a range of 0.1 minutes to 60 minutes.

In the above-mentioned production method, the laminated body may be temporarily adhered by subjecting the laminated body to room press at normal temperature (pressurization at normal temperature) before dry heat press is performed.

In the post step, dry heat press is performed, an electrolytic solution is then injected into the outer packaging material containing the laminated body, and the outer packaging material is sealed. After the electrolytic solution is injected, the laminated body may be further hot-pressed from above the outer packaging material, but a favorable adhering state can be maintained even when heat press is not performed. Preferably, the inside of the outer packaging material is brought into a vacuum state before sealing. Examples of the method of sealing the outer packaging material include a method in which an opening section of the outer packaging material is adhered with an adhesive; and a method in which an opening section of the outer packaging material is heated and pressurized to perform thermocompression adhesion.

### EXAMPLES

The separators and the non-aqueous secondary batteries of the first and second embodiments will be described further in detail below with reference to the examples. Materials, use amounts, ratios, process procedures, and the like shown in the following examples can be appropriately changed without departing from the spirit of the invention. Therefore, the scope of the separator and the non-aqueous secondary battery of the invention should not be construed to be limited by the following specific examples.

<Measurement Methods and Evaluation Methods>

Measurement methods and evaluation methods applied in examples and comparative examples are as follows.

[Composition of Polyvinylidene Fluoride type Resin]

20 mg of polyvinylidene fluoride type resin was dissolved in 0.6 ml of heavy dimethyl sulfoxide at 100° C., a ¹⁹F-NMR spectrum was measured at 100° C., and the composition of the polyvinylidene fluoride type resin was determined from the NMR spectrum.

[Weight Average Molecular Weight of Resin]

The weight average molecular weight (Mw) of the resin was measured as a molecular weight in terms of polystyrene under the condition of a temperature of 40° C. and a flow rate of 10 ml/min by using a gel permeation chromatography analyzer (GPC-900 from JASCO Corporation), using two columns: TSKgel SUPER AWM-H from TOSOFI CORPORATION, and using N,N-dimethylformamide as a solvent.

[Glass Transition Temperature of Resin]

The glass transition temperature of the resin was determined from a differential scanning calorimetry curve (DSC curve) obtained by performing differential scanning calorimetry (DSC). The glass transition temperature is a temperature at a point where a straight line obtained by extending a base line on the low temperature side to the high temperature side crosses a tangent line of a curve at a step-like change part, which has the largest gradient.

[Thickness of Each of Porous Substrate and Separator]

The thickness (μm) of each of the porous substrate and the separator was determined by measuring the thickness at 20 spots within using a contact-type thickness meter (LITEMAFIC manufactured by Mitutoyo Corporation), and averaging the measured values. As a measurement terminal, a terminal having a circular-cylindrical shape with a diameter of 5 mm was used, and an adjustment was made so that a load of 7 g was applied during the measurement.

[Layer Thickness of Adhesive Porous Layer]

For the layer thickness (μm) of the adhesive porous layer, a total layer thickness on both sides was determined by subtracting the thickness of the porous substrate from the thickness of the separator, and a half of the total layer thickness was defined as a layer thickness on one side.

[Gurley Value]

The Gurley value (seconds/100 cc) of each of the porous substrate and the separator was measured using a Gurley-type Densometer (G-B2C from TOYO SEIKI SESAKU-SHO) in accordance with JIS P8117: 2009.

[Porosity]

The porosity (%) of each of the porous substrate and the adhesive porous layer was determined in accordance with the following formula.

ε=1−Ws/(ds·t)×100 where ε represents a porosity (%)

In the formula, Ws represents a basis weight (g/m²), ds represents a true density (g/cm), and t represents a thickness (μm).

[Peeling Strength between Porous Substrate and Adhesive Porous Layer]

An adhesive tape was attached to one surface of the separator (the longitudinal direction of the adhesive tape was made coincident with the MD direction of the separator in attachment of the tape), and the separator, together with the adhesive tape, was cut to a size of 1.2 cm in the TD direction and 7 cm in the MD direction. The adhesive tape was slightly peeled off together the adhesive porous layer immediately below the tape, two separated end parts were held in Tensilon (RTC-1210A manufactured by Orientec Co., Ltd.), and a T-shape peeling test was conducted. The adhesive tape was used as a support for peeling the adhesive porous layer from the porous substrate. The tension speed in the T-shape peeling test was set to 20 mm/min, and a load (N) in peeling of the adhesive porous layer from the porous substrate was measured. A load was measured at intervals of 0.4 mm up to 40 nun from 10 mm after the start of measurement, and an average thereof was calculated, and converted into a load per width of 10 mm (N/10 mm). Further, measured values for three test pieces were averaged, and the average was defined as a peeling strength (N/10 mm).

[Adhesive Strength to Positive Electrode: Dry Heat Press]

89.5 g of lithium cobalt oxide powder as a positive electrode active material, 4.5 g of acetylene black as a conductive auxiliary agent, and 6 g of polyvinylidene fluoride as a binder were dissolved in N-methyl-pyrrolidone such a manner that the concentration of the polyvinylidene fluoride would be 6% by mass, and the resultant solution was stirred in a dual arm-type mixer to prepare a positive electrode slurry. The positive electrode slurry was applied to one surface of a 20 μm-thick aluminum foil, and dried, and pressing was then performed to obtain a positive electrode having a positive electrode active material layer.

The positive electrode obtained as described above was cut to a width of 1.5 cm and a length of 7 cm, and the separator was cut to a size of 1.8 cm in the TD direction and 7.5 cm in the MD direction. The positive electrode and the separator were superposed on each other, and hot-pressed under the condition of a temperature of 80° C., a pressure of 5.0 MPa, and a time of 3 minutes to adhere the positive electrode to the separator with each other, thereby obtaining a test piece. The separator was slightly peeled from the positive electrode at one end of the test piece in the length direction (i.e. MD direction of the separator), two separated end parts were held in Tensilon (RTC-1210A manufactured by Orientec Co., Ltd.), and a T-shape peeling test was conducted. The tension speed in the T-shape peeling test was set to 20 mm/min, and a load (N) in peeling of the separator from the positive electrode was measured, a load was measured at intervals of 0.4 mm up to 40 nun from 10 mm after the start of measurement, and an average thereof was calculated. Further, measured values for three test pieces were averaged, and the average was defined as a adhesive strength (N) of the separator.

[Adhesiveness to Positive Electrode: after Immersion in Electrolytic Solution]

The positive electrode and the separator after the dry heat press adhering, which were obtained as described above [Adhesive strength with Positive Electrode], were immersed in an electrolytic solution (1 mol/L LiPF₆-ethylene carbonate: ethylmethyl carbonate [mass ratio 3:7]) at room temperature for 24 hours, and then taken out from the electrolytic solution, the separator was picked up by hand, and peeled from the positive electrode, and adhesiveness after the immersion in the electrolytic solution was examined in accordance with the following criteria.

A: Firm adhering (the separator is not detached from the electrode only by reversing the sample, and microscopic observation after peeling shows that the adhesive porous layer is abundantly deposited on the electrode surface).

B: Sufficient adhering (the separator is not detached from the electrode only by reversing the sample, and microscopic observation after peeling shows that the adhesive porous layer is slightly deposited on the electrode surface)

C: Weak adhering (the separator is not detached from the electrode only by reversing the sample, but can be easily peeled by hand, and microscopic observation after peeling shows that little adhesive porous layer remains on the electrode surface).

D: Not adhering (the separator is detached from the electrode just by reversing the sample, and the separator and the electrode are not completely adhered to each other).

[Adhesive Strength to Negative Electrode]

300 g of artificial graphite as a negative electrode active material, 7.5 g of water-soluble dispersion liquid which contained 40% by mass of modified product of styrene-butadiene copolymer, as a binder, 3 g of carboxymethylcellulose as a thickener, and a proper amount of water were stirred in a dual arm-type mixer to prepare negative electrode slurry. The negative electrode slurry was applied to one surface of a 10 μm-thick copper foil, and dried, and pressing was then performed to obtain a negative electrode having a negative electrode active material layer.

Using the negative electrode obtained as described above, a T-shape peeling test was conducted in the same manner as described above in [Adhesive strength to Positive Electrode: Dry Heat Press] to determine a adhesive strength (N) of the separator.

[Adhesiveness to Negative Electrode: after Immersion in Electrolytic Solution]

Using the negative electrode obtained as described above, adhesiveness after immersion in the electrolytic solution was examined in the same manner as described above [Adhesiveness to Positive Electrode: after Immersion in Electrolytic Solution].

[Cycle Characteristic (Capacity Retention Ratio)]

A lead tab was welded to the positive electrode and negative electrode, and the positive electrode, the separator, and the negative electrode were laminated in this order. The resulting laminated body was inserted into a pack made of an aluminum laminate film, the inside of the pack was brought into vacuum state and temporarily sealed using a vacuum sealer, and the pack was hot-pressed in the lamination direction of the laminated body using a hot-pressing machine, thereby adhering the electrodes and the separator to each other. As conditions for hot-pressing, the temperature was 90° C., the load per 1 cm² of electrode was 20 kg, and the pressing time was 2 minutes. Then, an electrolytic solution (1mol/L LiPF₆-ethylene carbonate:ethylmethyl carbonate [mass ratio 3:7]) was injected into the pack, the laminated body was impregnated with the electrolytic solution, and the inside of the pack was brought into a vacuum state and sealed using a vacuum sealer, thereby obtaining a battery.

The battery was charged and discharged for 500 cycles wider an environment at a temperature of 40° C. Charge was constant current and constant voltage charge at 1 C and 4.2 V, and discharge was constant current discharge of 1 C and a 2.75 V cutoff. A discharge capacity at the 500th cycle was divided by an initial capacity, an average for ten batteries was calculated, and the obtained value (%) was defined as a capacity retention ratio.

[Load Characteristic]

A battery was produced in the same manner as in production of a battery [Cycle Characteristic (Capacity Retention Ratio)]. The battery was charged and discharged under an environment at a temperature of 15° C., a discharge capacity in discharge at 0.2 C and a discharge capacity in discharge at 2 C were measured, the latter was divided by the former, an average for ten batteries was calculated, and the obtained value (%) was defined as a load characteristic. As charge conditions, constant current and constant voltage charge was performed at 0.2 C and 4.2 V for 8 hours, and as discharge conditions, constant current discharge was performed at a 2.75 V cutoff.

Hereinafter, an embodiment according to the first embodiment will be described in detail by way of Examples 1 to 23 and Comparative Examples 1 to 7. Here, Comparative Examples 1 to 7 are examples of an embodiment which is not encompassed in the scope of the first embodiment.

<Preparation of Separator>

### Example 1

A polyvinylidene fluoride type resin (VDF-HFP copolymer, HFP unit content: 12.4% by mass, weight average molecular weight: 860,000) and an acrylic type resin (methyl methacrylate-styrene copolymer, polymerization ratio [mass ratio]: 50:50, weight average molecular weight: 115,000, glass transition temperature: 105° C.) were dissolved in a mixed solvent of dimethylacetamide and tripropylene glycol (dimethylacetamide:tripropylene glycol=80:20 [mass ratio]) to prepare a coating liquid for formation of an adhesive porous layer. The mass ratio of the polyvinylidene fluoride type resin and the acrylic type resin contained in the coating liquid was 80:20, and the resin concentration of the coating liquid was 5.0% by mass.

The coating liquid was applied to both surfaces of a polyethylene micro-porous membrane (thickness: 9.0 μm, Gurley value: 150 sec/100 cc, porosity: 43%) as a porous substrate (here, the amounts of the coating liquid applied to front and back surfaces were equal to each other), and immersed in a coagulation liquid (water:dimethylacetamide:tripropylene glycol=62.5:30:7.5 [mass ratio], liquid temperature: 35° C.) to solidify the coating liquid. The coated membrane was washed with water and dried to obtain a separator with an adhesive porous layer formed on both surfaces of a polyethylene micro-porous membrane.

### Example 2

Except that as the acrylic type resin, a terpolymer of methyl methacrylate-styrene-unsaturated carboxylic anhydride (polymerization ratio [mass ratio]: 10:70:20, weight average molecular weight: 113,000, glass transition temperature 130° C.) was used, the same procedure as in Example 1 was carried out to prepare a separator.

### Example 3

Except that as the acrylic type resin, a terpolymer of methyl methacrylate-styrene-unsaturated carboxylic anhydride (polymerization ratio [mass ratio]: 30:50:20, weight average molecular weight: 130,000, glass transition temperature 115° C.) was used, the same procedure as in Example 1 was carried out to prepare a separator.

### Example 4

Except that as the acrylic type resin, a methyl methacrylate-styrene copolymer (polymerization ratio [mass ratio]: 40:60, weight average molecular weight: 119,000, glass transition temperature 108° C.) was used, the same procedure as in Example 1 was carried out to prepare a separator.

### Example 5

Except that as the acrylic type resin, a methyl methacrylate-styrene copolymer (polymerization ratio [mass ratio]: 20:80, weight average molecular weight: 109,000, glass transition temperature: 112° C.) was used, the same procedure as in Example 1 was carried out to prepare a separator.

### Examples 6 to 10

Except that the mass ratio of the polyvinylidene fluoride type resin and the acrylic type resin contained in the coating liquid was changed as described in Table 1, the same procedure as in Example 1 was carried out to prepare separators.

### Example 11

Except that magnesium hydroxide particles (volume average particle size of primary particles: 0.8 μm, BET specific surface area: 6.8 m²/g) were further dispersed in the coating liquid so as to obtain a content as described in Table 1, the same procedure as in Example 1 was carried out to prepare a separator.

### Example 12

Except that magnesium hydroxide particles (volume average particle size of primary particles: 0.8 μm, BET specific surface area: 6.8 m²/g) were further dispersed in the coating liquid so as to obtain a content as described in Table 1, the same procedure as in Example 2 was carried out to prepare a separator.

### Example 13

Except that magnesium hydroxide particles (volume average particle size of primary particles: 0.8 μm, BET specific surface area: 6.8 m²/g) were further dispersed in the coating liquid so as to obtain a content as described in Table 1, the same procedure as in Example 3 was carried out to prepare a separator.

### Comparative Example 1

Except that the coating liquid did not contain an acrylic type resin, the same procedure as in Example 1 was carried out to prepare a separator.

### Comparative Example 2

Except that the coating liquid did not contain an acrylic type resin, and the contents of the polyvinylidene fluoride type resin and the magnesium hydroxide particles were changed as described in Table 1, the same procedure as in Example 11 was carried out to prepare a separator.

### Comparative Example 3

Except that the mass ratio of the polyvinylidene fluoride type resin and the acrylic type resin contained in the coating liquid was changed as described in Table 1, the same procedure as in Example 1 was carried out to prepare a separator.

### Comparative Example 4

Except that the acrylic type resin contained in the coating liquid was changed to a methyl methacrylate-methacrylic acid copolymer (polymerization ratio [mass ratio]: 90:10, weight average molecular weight: 85,000, glass transition temperature 80° C.), and mass ratio of the polyvinylidene fluoride type resin and the acrylic type resin was changed as described in Table 1, the same procedure as in Example 1 was carried out to prepare a separator.

Physical properties and evaluation results of the separators of Examples I to 13 and Comparative Examples 1 to 4 are shown in Table 1.

TABLE 1

| | | | | | | | | | | | | | | | | Com- | Com- | Com- | Com- |
|---|---|---|---|---|---|---|---|---|---|---|---|---|---|---|---|---|---|---|---|
| | | | | | | | | | | | | | | | | par- | par- | par- | par- |
| | | | | | | | | | | | | | | | | ative | ative | ative | ative |
| | | | Ex- | Ex- | Ex- | Ex- | Ex- | Ex- | Ex- | Ex- | Ex- | Ex- | Ex- | Ex- | Ex- | Ex- | Ex- | Ex- | Ex- |
| | | | ample | ample | ample | ample | ample | ample | ample | ample | ample | ample | ample | ample | ample | ample | ample | ample | ample |
| | | | 1 | 2 | 3 | 4 | 5 | 6 | 7 | 8 | 9 | 10 | 11 | 12 | 13 | 1 | 2 | 3 | 4 |
| Adhesive | PVDF | HFP unit content | 12.4 | 12.4 | 12.4 | 12.4 | 12.4 | 12.4 | 12.4 | 12.4 | 12.4 | 12.4 | 12.4 | 12.4 | 12.4 | 12.4 | 12.4 | 12.4 | 12.4 |
| porous | type | [% by mass] | | | | | | | | | | | | | | | | | |
| layer | resin | Mw | 86 | 86 | 86 | 86 | 86 | 86 | 86 | 86 | 86 | 86 | 86 | 86 | 86 | 86 | 86 | 86 | 86 |
| | Acrylic | Acrylic type | 50 | 10 | 30 | 40 | 20 | 50 | 50 | 50 | 50 | 50 | 50 | 10 | 30 | — | — | 50 | 100 |
| | type | monomer unit | | | | | | | | | | | | | | | | | |
| | resin | content | | | | | | | | | | | | | | | | | |
| | | [% by mass] | | | | | | | | | | | | | | | | | |
| | | Styrene type | 50 | 70 | 50 | 60 | 80 | 50 | 50 | 50 | 50 | 50 | 50 | /0 | 50 | — | — | 50 | 0 |
| | | monomer unit | | | | | | | | | | | | | | | | | |
| | | content | | | | | | | | | | | | | | | | | |
| | | [% by mass] | | | | | | | | | | | | | | | | | |
| | | Maleic | 0 | 20 | 20 | 0 | 0 | 0 | 0 | 0 | 0 | 0 | 0 | 20 | 20 | — | — | 0 | 0 |
| | | anhydride | | | | | | | | | | | | | | | | | |
| | | unit content | | | | | | | | | | | | | | | | | |
| | | [% by mass] | | | | | | | | | | | | | | | | | |
| | Content | PVDF type resin | 80 | 80 | 80 | 80 | 80 | 90 | 70 | 66 | 98 | 60 | 32 | 32 | 32 | 100 | 40 | 50 | 75 |
| | of | Acrylic type | 20 | 20 | 20 | 20 | 20 | 10 | 30 | 34 | 2 | 40 | 8 | 8 | 8 | — | — | 50 | 25 |
| | solid [% | resin | | | | | | | | | | | | | | | | | |
| | by mass] | Filler | — | — | — | — | — | — | — | — | — | — | 60 | 60 | 60 | — | 60 | — | — |

| | | | | | | | | | | | | | | | | | | |
|---|---|---|---|---|---|---|---|---|---|---|---|---|---|---|---|---|---|---|
| | Layer thickness | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| | (one side) [μm] | | | | | | | | | | | | | | | | | |
| | Porosity [%] | 57 | 55 | 54 | 53 | 56 | 55 | 54 | 56 | 56 | 55 | 51 | 52 | 51 | 52 | 49 | 61 | 55 |
| | Peeling strength | 0.86 | 0.79 | 0.82 | 0.85 | 0.77 | 0.95 | 0.81 | 0.66 | 0.31 | 0.35 | 0.63 | 0.59 | 0.61 | 0.25 | 0.2 | 0.13 | 0.81 |
| | [N/10 mm] | | | | | | | | | | | | | | | | | |
| Physical | Thickness [μm] | 12 | 12 | 12 | 12 | 12 | 12 | 12 | 12 | 12 | 12 | 12 | 12 | 12 | 12 | 12 | 12 | 12 |
| properties | Gurley value [sec/100 cc] | 197 | 202 | 194 | 190 | 201 | 195 | 196 | 193 | 194 | 195 | 205 | 208 | 204 | 208 | 214 | 187 | 194 |
| of | Adhesive strength to | 151 | 148 | 146 | 147 | 139 | 148 | 154 | 138 | 107 | 118 | 96 | 101 | 99 | 100 | 85 | 89 | 150 |
| separator | positive electrode | | | | | | | | | | | | | | | | | |
| | (dry heat press) [%] | | | | | | | | | | | | | | | | | |
| | Adhesiveness to positive | C | C | C | C | C | C | C | C | C | C | C | C | C | D | D | D | D |
| | electrcode (after immersion | | | | | | | | | | | | | | | | | |
| | in electrolytic solution) | | | | | | | | | | | | | | | | | |
| | Adhesive strength | 220 | 210 | 180 | 172 | 155 | 175 | 164 | 143 | 108 | 115 | 110 | 102 | 97 | 100 | 80 | 98 | 145 |
| | to negative electrode | | | | | | | | | | | | | | | | | |
| | (dry heat press) [%] | | | | | | | | | | | | | | | | | |
| | Adhesiveness to negative | B | A | A | A | A | B | B | B | C | C | C | C | C | D | D | D | D |
| | electrode (after immersion | | | | | | | | | | | | | | | | | |
| | in electrolytic solution) | | | | | | | | | | | | | | | | | |
| Battery | Cycle characteristic [%] | 95 | 96 | 96 | 97 | 96 | 95 | 95 | 94 | 90 | 88 | 95 | 96 | 96 | 80 | 81 | 87 | 82 |
| evaluation | Load characteristic [%] | 93 | 94 | 94 | 95 | 94 | 93 | 92 | 92 | 89 | 88 | 93 | 94 | 94 | 80 | 77 | 83 | 83 |

<Preparation of Separator>

### Example 14

A polyvinylidene fluoride type resin (VDF-HFP copolymer, HFP unit content: 12.4% by mass, weight average molecular weight: 860,000) and an acrylic type resin (methyl methacrylate (MMA)-butyl acrylate (BA)-styrene copolymer, polymerization ratio [mass ratio]: 40:20:40, weight average molecular weight: 144,000, glass transition temperature: 64° C.) were dissolved in a mixed solvent of dimethylacetamide and tripropylene glycol (dimethylacetamide:tripropylene glycol=80:20 [mass ratio]) to prepare a coating liquid for formation of an adhesive porous layer. The mass ratio of the polyvinylidene fluoride type resin and the acrylic type resin contained in the coating liquid was 80:20, and the resin concentration of the coating liquid was 5.0% by mass.

The coating liquid was applied to both surfaces of a polyethylene micro-porous membrane (thickness: 9.0 μm, Gurley value: 150 sec/100 cc, porosity: 43%) as a porous substrate (here, the amounts of the coating liquid applied to front and back surfaces were equal to each other), and immersed in a coagulation liquid (water:dimethylacetamide:tripropylene glycol=62.5:30:7.5 [mass ratio], liquid temperature: 35° C.) to solidify the coating liquid. The coated membrane was washed with water and dried to obtain a separator with an adhesive porous layer formed on both surfaces of a polyethylene micro-porous membrane.

### Example 15

Except that as the acrylic type resin, a methyl methacrylate (MMA)-butyl acrylate (BA)-styrene copolymer (polymerization ratio [mass ratio]: 30:20:50, weight average molecular weight: 156,000, glass transition temperature: 67° C.) was used, the same procedure as in Example 14 was carried out to prepare a separator.

### Example 16

Except that as the acrylic type resin, a 2-hydroxyethyl methacrylate (2-HEMA)-butyl acrylate (BA)-styrene copolymer (polymerization ratio [mass ratio]: 10:18:72, weight average molecular weight: 115,000, glass transition temperature: 71° C.) was used, the same procedure as in Example 14 was carried out to prepare a separator.

### Example 17

Except that as the acrylic type resin, a 2-hydroxyethyl methacrylate (2-HEMA)-butyl acrylate (BA)-styrene copolymer (polymerization ratio [mass ratio]: 17:11:72, weight average molecular weight: 112,000, glass transition temperature: 83° C.) was used, the same procedure as in Example 14 was carried out to prepare a separator.

### Example 18

Except that as the acrylic type resin, a 2-hydroxyethyl methacrylate (2-HEMA)-ethyl acrylate (EA)-styrene copolymer (polymerization ratio [mass ratio]: 10:18:72, weight average molecular weight: 114,000, glass transition temperature: 80° C.) was used, the same procedure as in Example 14 was carried out to prepare a separator.

### Example 19

Except that as the acrylic type resin, a 2-hydroxyethyl methacrylate (2-HEMA)-ethyl acrylate (EA)-styrene copolymer (polymerization ratio [mass ratio]: 30:12:58, weight average molecular weight: 129,000, glass transition temperature: 86° C.) was used, the same procedure as in Example 14 was carried out to prepare a separator.

### Example 20

Except that as the acrylic type resin, a 2-hydroxyethyl methacrylate (2-HEMA)-ethyl acrylate (EA)-styrene copolymer (polymerization ratio [mass ratio]: 34:18:48, weight average molecular weight: 153,000, glass transition temperature: 78° C.) was used, the same procedure as in Example 14 was carried out to prepare a separator.

### Example 21

Except that as the acrylic type resin, an ethyl acrylate (EA)-methoxydiethylene glycol methacrylate (MDEGA, n=9)-styrene copolymer (polymerization ratio [mass ratio]: 10.5:10:79.5, weight average molecular weight: 133,000, glass transition temperature: 70° C.) was used, the same procedure as in Example 14 was carried out to prepare a separator.

### Example 22

Except that as the acrylic type resin, an ethyl acryl ate (EA)-methoxydiethylene glycol methacrylate (MDEGA, n=9)-styrene copolymer (polymerization ratio [mass ratio]: 5:20:75, weight average molecular weight: 160,000, glass transition temperature: 52° C.) was used, the same procedure as in Example 14 was carried out to prepare a separator.

### Example 23

Except that magnesium hydroxide particles (volume average particle size of primary particles: 0.8 μm, BET specific surface area: 6.8 m²/g) were further dispersed in the coating liquid so as to obtain a content as described in Table 2, the same procedure as in Example 14 was carried out to prepare a separator.

### Comparative Example 5

Except that the coating liquid did not contain an acrylic type resin, the same procedure as in Example 14 was carried out to prepare a separator.

### Comparative Example 6

Except that the coating liquid did not contain an acrylic type resin, and the contents of the polyvinylidene fluoride type resin and the magnesium hydroxide particles were changed as described in Table 2, the same procedure as in Example 14 was carried out to prepare a separator.

### Comparative Example 7

Except that the acrylic type resin contained in the coating liquid was changed to a methyl methacrylate (MMA)-methacrylic acid (MA) copolymer (polymerization ratio [mass ratio]: 90:10, weight average molecular weight: 85,000, glass transition temperature 80° C.), and mass ratio of the polyvinylidene fluoride type resin to the acrylic type resin was changed as described in Table 2. the same procedure as in Example 14 was carried out to prepare a separator.

Physical properties and evaluation results of the separators of Examples 14 to 23 and Comparative Examples 5 to 7 are shown in Table 2.

TABLE 2

| | | | | | | | | | | | | | Com- | Com- | Com- |
|---|---|---|---|---|---|---|---|---|---|---|---|---|---|---|---|
| | | | | | | | | | | | | | par- | par- | par- |
| | | | Ex- | Ex- | Ex- | Ex- | Ex- | Ex- | Ex- | Ex- | Ex- | Ex- | ative | ative | ative |
| | | | am- | am- | am- | am- | am- | am- | am- | am- | am- | am- | Ex- | Ex- | Ex- |
| | | | ple | ple | ple | ple | ple | ple | ple | ple | ple | ple | ample | ample | ample |
| | | | 14 | 15 | 16 | 17 | 18 | 19 | 20 | 21 | 22 | 23 | 5 | 6 | 7 |
| Ad- | PVDF | HFP unit | 12.4 | 12.4 | 12.4 | 12.4 | 12.4 | 12.4 | 12.4 | 12.4 | 12.4 | 12.4 | 12.4 | 12.4 | 12.4 |
| hesive | type | content | | | | | | | | | | | | | |
| porous | resin | [% by | | | | | | | | | | | | | |
| layer | | mass] | | | | | | | | | | | | | |
| | | Mw | 86 | 86 | 86 | 86 | 86 | 86 | 86 | 86 | 86 | 86 | 86 | 86 | 86 |
| | Acrylic | 2-HEMA | — | — | 10 | 17 | 10 | 30 | 34 | — | — | — | — | — | — |
| | type | unit | | | | | | | | | | | | | |
| | resin | content | | | | | | | | | | | | | |
| | | [% by | | | | | | | | | | | | | |
| | | mass] | | | | | | | | | | | | | |
| | | EA unit | — | — | — | — | 18 | 12 | 18 | 10.5 | 5 | — | — | — | — |
| | | content | | | | | | | | | | | | | |
| | | [% by | | | | | | | | | | | | | |
| | | mass] | | | | | | | | | | | | | |
| | | BA unit | 20 | 20 | 18 | 11 | — | — | — | — | — | 20 | — | — | — |
| | | content | | | | | | | | | | | | | |
| | | [% by | | | | | | | | | | | | | |
| | | mass] | | | | | | | | | | | | | |
| | | MMA unit | 40 | 30 | — | — | — | — | — | — | — | 40 | — | — | 90 |
| | | content | | | | | | | | | | | | | |
| | | [% by | | | | | | | | | | | | | |
| | | mass] | | | | | | | | | | | | | |
| | | MA unit | — | — | — | — | — | — | — | — | — | — | — | — | 10 |
| | | content | | | | | | | | | | | | | |
| | | [% by | | | | | | | | | | | | | |
| | | mass] | | | | | | | | | | | | | |
| | | MDEGA | — | — | — | — | — | — | — | 10 | 20 | — | — | — | — |
| | | unit | | | | | | | | | | | | | |
| | | content | | | | | | | | | | | | | |
| | | [% by | | | | | | | | | | | | | |
| | | mass] | | | | | | | | | | | | | |
| | | Styrene | 40 | 50 | 72 | 72 | 72 | 58 | 48 | 79.5 | 7.5 | 40 | — | — | 0 |
| | | type | | | | | | | | | | | | | |
| | | monomer | | | | | | | | | | | | | |
| | | unit | | | | | | | | | | | | | |
| | | content | | | | | | | | | | | | | |
| | | [% by | | | | | | | | | | | | | |
| | | mass] | | | | | | | | | | | | | |
| | Content | PVDE | 80 | 80 | 80 | 80 | 80 | 80 | 80 | 80 | 80 | 32 | 100 | 40 | 75 |
| | of solid | type resin | | | | | | | | | | | | | |
| | [% by | Acrylic | 20 | 20 | 20 | 20 | 20 | 20 | 20 | 20 | 20 | 8 | — | — | 25 |
| | mass] | type resin | | | | | | | | | | | | | |
| | | Filler | — | — | — | — | — | — | — | — | — | 60 | — | 60 | — |

| | | | | | | | | | | | | | | |
|---|---|---|---|---|---|---|---|---|---|---|---|---|---|---|
| | Layer thickness | 1.5 | 1.5 | 1.5 | 1.5 | 1.5 | 1.5 | 1.5 | 1.5 | 1.5 | 1.5 | 1.5 | 1.5 | 1.5 |
| | (one side) [μm] | | | | | | | | | | | | | |
| | Porosity (%) | | | | | | | | | | | | | |
| | Peeling strength | 0.84 | 0.82 | 0.73 | 0.68 | 0.74 | 0.71 | 0.72 | 0.73 | 0.71 | 0.61 | 0.25 | 0.2 | 0.81 |
| | [N/10 mm] | | | | | | | | | | | | | |
| Phys- | Thickness [μm] | 12 | 12 | 12 | 12 | 12 | 12 | 12 | 12 | 12 | 12 | 12 | 12 | 12 |
| ical | Gurley value | 196 | 200 | 195 | 194 | 193 | 192 | 199 | 195 | 195 | 192 | 208 | 214 | 194 |
| prop- | [sec/100 cc] | | | | | | | | | | | | | |
| erties | Adhesive | 165 | 160 | 146 | 130 | 135 | 128 | 126 | 153 | 147 | 121 | 100 | 85 | 150 |
| of | strength to | | | | | | | | | | | | | |
| sepa- | positive | | | | | | | | | | | | | |
| rator | electrode | | | | | | | | | | | | | |
| | (dry heat | | | | | | | | | | | | | |
| | press) [%] | | | | | | | | | | | | | |
| | Adhesiveness | C | C | C | C | C | C | C | C | C | C | D | D | D |
| | to positive | | | | | | | | | | | | | |
| | electrode | | | | | | | | | | | | | |
| | (after | | | | | | | | | | | | | |
| | immersion in | | | | | | | | | | | | | |
| | electrolytic | | | | | | | | | | | | | |
| | solution) | | | | | | | | | | | | | |
| | Adhesive | 275 | 240 | 164 | 136 | 148 | 144 | 138 | 165 | 155 | 152 | 100 | 80 | 145 |
| | strength | | | | | | | | | | | | | |
| | to negative | | | | | | | | | | | | | |
| | electrode | | | | | | | | | | | | | |
| | (dry heat | | | | | | | | | | | | | |
| | press) [%] | | | | | | | | | | | | | |
| | Adhesiveness | B | B | A | A | A | B | B | B | B | B | D | D | D |
| | to negative | | | | | | | | | | | | | |
| | electrode | | | | | | | | | | | | | |
| | (after | | | | | | | | | | | | | |
| | immersion | | | | | | | | | | | | | |
| | in electrolytic | | | | | | | | | | | | | |
| | solution) | | | | | | | | | | | | | |
| Battery | Cycle | 95 | 95 | 96 | 96 | 96 | 94 | 93 | 94 | 93 | 94 | 80 | 81 | 82 |
| eval- | characteristic | | | | | | | | | | | | | |
| uation | [%] | | | | | | | | | | | | | |
| | Load | 94 | 94 | 94 | 95 | 95 | 94 | 94 | 93 | 93 | 94 | 80 | 77 | 83 |
| | characteristic | | | | | | | | | | | | | |
| | [%] | | | | | | | | | | | | | |

Hereinafter, an embodiment according to the second embodiment will be described in detail with reference to the Examples 24 to 27 and Comparative Examples 8 to 11. Here, Comparative Examples 8 to 11 are examples of an embodiment which is not encompassed in the scope of the second embodiment.

<Preparation of Separator>

### Example 24

A polyvinylidene fluoride type resin (VDF-HFP copolymer, HFP unit content: 12.4% by mass, weight average molecular weight: 860,000) and an acrylic type resin (methyl methacrylate-polymethoxydiethylene glycol methacrylate (n=4), polymerization ratio [mass ratio]: 45:55, weight average molecular weight: 115,000, glass transition temperature: 55° C.) were dissolved in a mixed solvent of dimethylacetamide and tripropylene glycol (dimethylacetamide:tripropylene glycol=80:20 [mass ratio]) to prepare a coating liquid for formation of an adhesive porous layer. The mass ratio of the polyvinylidene fluoride type resin and the acrylic type resin contained in the coating liquid was 80:20, and the resin concentration of the coating liquid was 5.0% by mass.

The coating liquid was applied to both surfaces of a polyethylene micro-porous membrane (thickness: 9.0 μm, Gurley value: 150 sec/100 cc, porosity: 43%) as a porous substrate (here, the amounts of the coating liquid applied to front and back surfaces were equal to each other), and immersed in a coagulation liquid (water:dimethylacetamide:tripropylene glycol=62.5:30:7.5 [mass ratio], liquid temperature: 35° C.) to solidify the coating liquid. The coated membrane was washed with water and dried to obtain a separator with an adhesive porous layer formed on both surfaces of a polyethylene micro-porous membrane.

### Example 25

Except that as the acrylic type resin, methyl methacrylate-polymethoxydiethylene glycol methacrylate (n=9) (polymerization ratio [mass ratio]: 45:55, weight average molecular weight: 125,000, glass transition temperature: 55° C.) was used, the same procedure as in Example 24 was carried out to prepare a separator.

### Example 26

Except that magnesium hydroxide particles (volume average particle size of primary particles: 0.8 μm, BET specific surface area: 6.8 m²/g) were further dispersed in the coating liquid so as to obtain a content as described in Table 3, the same procedure as in Example 24 was carried out to prepare a separator.

### Example 27

Except that magnesium hydroxide particles (volume average particle size of primary particles: 0.8 μm. BET specific surface area: 6.8 m²/g) were further dispersed in the coating liquid so as to obtain a content as described in Table 3, the same procedure as in Example 25 was carried out to prepare a separator.

### Comparative Example 8

Except that the coating liquid did not contain an acrylic type resin, the same procedure as in Example 24 was carried out to prepare a separator.

### Comparative Example 9

Except that the coating liquid did not contain an acrylic type resin, and the contents of the polyvinylidene fluoride type resin and the magnesium hydroxide particles were changed as described in Table 3, the same procedure as in Example 26 was carried out to prepare a separator.

### Comparative Example 10

Solid poly[poly(ethylene glycol)methacrylate] was obtained using poly(ethylene glycol)methacrylate (manufactured by Aldrich Co. having an average molecular weight of 360. 3.0 parts by weight of the solid poly[poly (ethylene glycol)methacrylate], 2.0 parts by weight of polyvinylidene fluoride (manufactured by Aldrich Co. LLC.) having an average molecular weight (Mw) of 534000, and 95 parts by weight of NMP were mixed at this composition ratio, and the mixture was sufficiently stirred so as to form a uniform solution, thereby preparing a viscous adhesive.

The adhesive was applied to both surfaces of a polyethylene micro-porous membrane (thickness: 9.0 μm, Gurley value: 150 sec/100 cc, porosity: 43%) as a porous substrate. Then, before the adhesive was dried, a positive electrode and a negative electrode were brought into close contact with each other so as to face each other with a separator sandwiched therebetween, and were stuck together to prepare a battery laminated body in which the positive electrode, the separator and the negative electrode were adhered together. The stuck battery laminated body was placed in a hot-air dryer at 60° C. for 2 hours to evaporate NMP. After NMP was fully evaporated, the battery laminated body was placed in a pack, an electrolytic solution (1 mol/L LiPF₆-ethylene carbonate:ethylmethyl carbonate [mass ratio 3:7]) was injected, the laminated body was impregnated with the electrolytic solution, and the inside of the pack was brought into a vacuum state and sealed using a vacuum sealer, thereby obtaining a battery.

For the adhesive strength between the electrode and the separator, the adhesive was applied to one surface of the separator, and the separator was placed in a hot-air dryer at 60° C. for 2 hours to evaporate NMP, and then cut to a size of 1.8 cm in the TD direction and 7.5 cm in the MD direction. Next, the electrode cut to a width of 1.5 cm and a length of 7 cm and the cut separator were superposed on each other, and hot-pressed under the condition of a temperature of 80° C., a pressure of 5.0 MPa and a time of 3 minutes to adhere the electrode to the separator with each other, and the thus-obtained product was used as a test piece.

### Comparative Example 11

Except that an adhesive was prepared using 3.0 parts by weight of polyethylene glycol (manufactured by Aldrich Co. LLC.) having an average molecular weight (Mw) of 10,000, and 2.0 parts by weight of polyvinylidene fluoride (manufactured by Aldrich Co. LLC.) having an average molecular weight (Mw) of 534000, the same procedure as in Comparative Example 10 was carried out to prepare a battery.

Physical properties and evaluation results of the separators of Examples 24 to 27 and Comparative Examples 8 to 11 are shown in Table 3.

TABLE 3

| | | | | | | | Compar- | Compar- | Compar- | Compar- |
|---|---|---|---|---|---|---|---|---|---|---|
| | | | | | | | ative | ative | ative | ative |
| | | | Ex- | Ex- | Ex- | Ex- | Ex- | Ex- | Ex- | Ex- |
| | | | ample | ample | ample | ample | ample | ample | ample | ample |
| | | | 24 | 25 | 26 | 27 | 8 | 9 | 10 | 11 |
| Adhesive | PVDF | HFP unit content | 12.4 | 12.4 | 12.4 | 12.4 | 12.4 | 12.4 | — | — |
| porous | type | [% by mass] | | | | | | | | |
| layer | resin | Mw | 86 | 86 | 86 | 86 | 86 | 86 | 53.4 | 53.4 |
| | Acrylic | MMA unit content | 45 | 45 | 45 | 45 | — | — | — | — |
| | type | [% by mass] | | | | | | | | |
| | resin | PMDEGM (n = 9) | 55 | — | 55 | — | — | — | — | — |
| | | unit content | | | | | | | | |
| | | [% by mass] | | | | | | | | |
| | | PMDEGM (n = 4) | — | 55 | — | 55 | — | — | — | — |
| | | unit content | | | | | | | | |
| | | [% by mass] | | | | | | | | |
| | Content | PVDF type resin | 80 | 80 | 32 | 32 | 100 | 40 | 60 | 60 |
| | of solid | Acrylic type resin | 20 | 20 | 8 | 8 | — | — | 40 | — |
| | [% by | Polyethylene | — | — | — | — | — | — | — | 40 |
| | mass] | glycol type resin | | | | | | | | |
| | | Filler | — | — | 60 | 60 | — | 60 | — | — |

| | | | | | | | | | |
|---|---|---|---|---|---|---|---|---|---|
| | Layer thickness one side) [μm] | 1.5 | 1.5 | 1.5 | 1.5 | 1.5 | 1.5 | — | — |
| | Porosity [%] | 57 | 56 | 54 | 55 | 52 | 49 | — | — |
| | Peeling strength [N/10 mm] | 0.76 | 0.75 | 0.55 | 0.52 | 0.25 | 0.2 | — | — |
| Physical | Thickness [μm] | 12 | 12 | 12 | 12 | 12 | 12 | — | — |
| properties | Gurley value [sec/100 cc] | 195 | 198 | 194 | 192 | 208 | 214 | — | — |
| of | Adhesive strength to positive | | | | | | | | |
| separator | electrode (dry heat press): [%] | 144 | 139 | 108 | 103 | 100 | 85 | 97 | 85 |
| | Adhesive strength to negative | 195 | 184 | 107 | 104 | 100 | 80 | 95 | 82 |
| | electrode (dry heat press) [%] | | | | | | | | |
| | Cycle characteristic [%] | 98 | 97 | 97 | 98 | 80 | 81 | 86 | 88 |
| | Battery evaluation | | | | | | | | |
| | Load characteristic [%] | 96 | 95 | 95 | 96 | 80 | 77 | 83 | 85 |

What is claimed is:

1. A separator for a non-aqueous secondary battery, comprising:
a porous substrate; and
an adhesive porous layer that is provided on one side or both sides of the porous substrate and contains an acrylic type resin and a polyvinylidene fluoride type resin, wherein:
the adhesive porous layer has a porous structure in which the acrylic type resin and the polyvinylidene fluoride type resin are contained in a mixed state,
a content of the acrylic type resin in the adhesive porous layer is from 2% by mass to 40% by mass with respect to a total mass of the acrylic type resin and the polyvinylidene fluoride type resin, and
the acrylic type resin is a copolymer containing an acrylic type monomer and a styrene type monomer as monomer components.

2. The separator for a non-aqueous secondary battery according to claim 1, wherein the acrylic type resin is a copolymer containing an acrylic type monomer, a styrene type monomer, and an unsaturated carboxylic anhydride as monomer components.

3. The separator for a non-aqueous secondary battery according to claim 1, wherein the acrylic type monomer is at least one selected from the group consisting of an acrylic acid, an acrylic acid salt, an acrylic acid ester, a methacrylic acid, a methacrylic acid salt and a methacrylic acid ester.

4. The separator for a non-aqueous secondary battery according to claim 1, wherein the acrylic type resin is a terpolymer containing, as monomer components, two acrylic type monomers selected from the group consisting of 2-hydroxyethyl methacrylate, ethyl acrylate, butyl acrylate, methyl methacrylate and polymethoxydiethylene glycol (meth)acrylate, and a styrene type monomer.

5. The separator for a non-aqueous secondary battery according to claim 1, wherein the polyvinylidene fluoride type resin is a copolymer containing vinylidene fluoride and hexafluoropropylene as monomer components, a content of the hexafluoropropylene monomer component in the copolymer is from 3% by mass to 20% by mass, and a weight average molecular weight of the copolymer is from 100,000 to 1,500,000.

6. A non-aqueous secondary battery comprising:
a positive electrode,
a negative electrode, and
the separator for a non-aqueous secondary battery according to claim 1, which is disposed between the positive electrode and the negative electrode,
wherein an electromotive force is produced by lithium doping and dedoping.

7. A separator for a non-aqueous secondary battery, comprising:
a porous substrate; and
an adhesive porous layer that is provided on one side or both sides of the porous substrate and contains an acrylic type resin and a polyvinylidene fluoride type resin, wherein:
the adhesive porous layer has a porous structure in which the acrylic type resin and the polyvinylidene fluoride type resin are contained in a mixed state,
a content of the acrylic type resin in the adhesive porous layer is from 2% by mass to 40% by mass with respect to a total mass of the acrylic type resin and the polyvinylidene fluoride type resin, and
the acrylic type resin is a copolymer containing, as monomer components, a first monoacrylate type monomer, and a second monoacrylate type monomer that has an oxyalkylene structural unit with a repetition number of from 2 to 10,000.

8. The separator for a non-aqueous secondary battery according to claim 7, wherein the first monoacrylate type monomer has at least one structural unit selected from the group consisting of an acrylic acid, an acrylic acid salt, an acrylic acid ester, a methacrylic acid, a methacrylic acid salt and a methacrylic acid ester.

9. The separator for a non-aqueous secondary battery according to claim 7, wherein a ratio of the second monoacrylate type monomer in the acrylic type resin is from 30% by mass to 95% by mass.

10. The separator for a non-aqueous secondary battery according to claim 7, wherein the polyvinylidene fluoride type resin is a copolymer containing vinylidene fluoride and hexafluoropropylene as monomer components, a content of the hexafluoropropylene monomer component in the copolymer is from 3% by mass to 20% by mass, and a weight average molecular weight of the copolymer is from 100,000 to 1,500,000.

11. A non-aqueous secondary battery comprising:
a positive electrode,
a negative electrode, and
the separator for a non-aqueous secondary battery according to claim 7, which is disposed between the positive electrode and the negative electrode,
wherein an electromotive force is produced by lithium doping and dedoping.
